(19) United States
(12) Patent Application Publication
(10) Pub. No.: US 2018/0157629 A1
(43) Pub. Date: Jun. 7, 2018

(54) Method for reducing data transfer from a server to a portable device

(71) Applicant: Raja Singh Tuli, Montreal (CA)

(72) Inventor: Raja Singh Tuli, Montreal (CA)

(21) Appl. No.: 15/366,538

(22) Filed: Dec. 1, 2016

(51) Int. Cl. G06F 17/22; G06F 17/21; H04L 29/08

(52) U.S. Cl. CPC G06F 17/2288; G06F 17/2247; H04L 67/02; G06F 17/212; H04L 67/2828; G06F 17/2205

(57) ABSTRACT

The invention discloses a method for accessing and viewing Internet content on a portable device by means of a proxy server, which method reduces the amount of data transferred to the device and improves its performance. Based on the content of each part of a web page, the server calculates, assigns and saves unique identifiers for each of them. If the web page is revisited or refreshed, unique identifiers are calculated and assigned for parts of this revisited or refreshed page. Parts that have the same identifier as a part previously saved are not transferred as the part with the same identifier in a memory of the device is instead used for display. Various processes can be combined with this method to reduce the number of instances by which the display of the device is refreshed and to optimally adapt the settings of the server's browser.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM (EFS-WEB)

Not Applicable

### STATEMENT REGARDING PRIOR DISCLOSURES BY THE INVENTOR OR A JOINT INVENTOR

Not applicable

### BACKGROUND OF THE INVENTION

### Field of the Invention

This invention relates to a host computer system. After receiving web content from a web page server, the browser of a host computer renders the web page on a virtual display of the host computer, a frozen or snapshot image of which is transmitted in parts and received through a network by a Portable Device. The Portable Device displays the web page image to the user, allows the user to navigate the web page and relays user input back to the Proxy server through a network. The invention relates to methods of remote data accessing, data processing, storage, display and interface display management that reduce the amount of data transferred from a host computer to a Portable Device in a network and improve the performance of the Portable Device.

Description of the Related Art

Aspects of the prior art that are necessary for explaining the present invention include U.S. Pat. Nos. 8,201,093, 8,176,428, 7,356,570 and 7,289,244 by the same Inventor.

As used in this specification and in the prior art, the term “web page server” designates a computer system that is separated from both the Portable Device and the Proxy server by a certain distance, and which communicates with both by means of a network. Communications between the web page server and the Portable Device are performed through the Proxy server. In most situations, the web page server provides access to the content of a web page in a website for instance, Yahoo, Google, CNN or similar ones.

As used in this specification and in the prior art, the term “Proxy server” designates a computer system that is separated from both the Portable Device and the web page server by a certain distance, and which establishes the communication link between both by means of a network. Through this network, content is received from the web page server by a Proxy server, where it is rendered before being transmitted in a compressed format to the Portable Device. The Proxy server can also communicate with the Portable Device and send to it, as well as receive from it, vector or ASCII content. The Proxy server typically runs applications, such as a web browsing application, according to default or user instructions.

As used in this specification and in the prior art, the term “Portable Device” designates an electronic device that is of reasonably small dimensions and whose functions include relaying user input to other computers and displaying information received from other computers, typically a Proxy server. The Portable Device is capable of receiving vector, ASCII and raster data and is capable of transmitting vector and ASCII data. The Portable Device communicates with other computers by means of a network, usually through a Proxy server. The Portable Device is capable of decompressing compressed image data received from the Proxy server, displaying it and scrolling through the image.

In the preferred embodiment of the prior art, when a user requests a web page, content for that web page is transmitted from the web page server to the Proxy server in the form of HTML, JAVA, JPEG, and other types of information. An image of this content for the web page is rendered as a virtual image on the Proxy server, which then takes a single frozen image frame or snapshot of the virtual image whereby no pixels change in this frame. The Proxy server thereafter divides this snapshot image into blocks of data, compresses these blocks and sends them along with instructions to the Portable Device, which, upon reception, decompresses these blocks and processes the instructions so that an image of the web page can be stored into a cache memory of the Portable Device and displayed on the Portable Device's screen.

The dimensions of the Portable Device's display screen determine to a certain extent the standard dimensions of the virtual display on which content received from the web page server would normally be rendered by the Proxy server's browser. If the dimensions of the Portable Device's screen are communicated to web page servers, the amount of content sent by the web page server to the Proxy server takes these dimensions into account. Any size limitation of the Portable Device's screen is thus indirectly passed on to the browser's standard virtual display. As a result, it happens frequently that a requested web page hosted by the web page server contains too much information for it to be entirely transmitted to the Proxy server, and thus to be entirely displayed on this standard virtual image upon the initial transmission of data. In these cases, the web page server only transmits partial content for the requested web page to the Proxy server's browser, by taking into consideration the declared size limitations of the Portable Device's screen.

In the preferred embodiment of prior art disclosed herein, after taking a snapshot image of its virtual display, the Proxy server sends instructions and blocks of data to the Portable Device in a specific order of priority. In this standard order, the Proxy server sends as a first priority data and display instructions for the display area of the Portable Device followed, as a second priority, with data and instructions for a small field around the displayable area of the Portable Device. If the user eventually shows intent to view another area of the web page, for instance by scrolling down to the break limit of content previously sent to the Portable Device, the Proxy server sends content for this additional portion to the Portable Device. In some cases, this transmission requires that the Proxy server requests additional content for the web page from the web page server because the area scrolled over by the user exceeds the initial transfer of data from the web page server to the Proxy server. For each of these sequences of data transmission from the Proxy server to the Portable Device, the Proxy server first sends graphic elements such as pictures, which are followed by blocks of data constituting non-graphic elements, like text. In the preferred embodiment of prior art disclosed herein, blocks of data received from the Proxy server are stored in a display memory of the Portable Device, ready to be instantly displayed should the user scroll over them. The user can then navigate the web page from the display memory of the Portable Device. This routine is performed again every time the user's navigation causes a new web page or a new portion of a web page to be loaded on the Proxy server's virtual display. This way, if the transmission is a newly-accessed web page, its image eventually replaces the previous one at the screen of the Portable Device. In the case of an additional web page portion for a web page, this portion attaches itself to the other portion(s) previously loaded for the web page.

In the preferred embodiment of prior art disclosed herein, a method is implemented in order to reduce the amount of data that is sent from the Proxy server to the Portable Device. In this prior art method, when the Proxy server loads a web page that has been previously viewed or when it refreshes the web page currently viewed, it executes a correlation analysis to determine what data needs to be sent to the Portable Device. The correlation analysis consists of comparing blocks of data or parts of a web page image that are positioned at the same positions between a snapshot image of a web page just loaded or refreshed and an image of that same web page stored into the Portable Device's and the Proxy server's cache memories. The Proxy server sends data for the web page just loaded or refreshed only if their corresponding blocks stored into cache memories of the Proxy server and the Portable Device—at the same graphic locations—are not the same. If they are the same, the Proxy server simply instructs the Portable Device to copy those blocks from the web page image stored into its cache memory.

Throughout the user's navigation, the Proxy server's browser can communicate information to web page servers. Among the various ways it communicates with web page servers, the Proxy server's browser can send to them, along with the requests for accessing web content or shortly thereafter, a User-Agent string—a set of self-identifying components such as the type of browser (among others, Chrome, Opera, Opera Mini, UC Browser and Safari); technical details about that browser, including its rendering engine; the type of device or desktop computer on which the browser runs or, in the case where the browser runs on a Proxy server in a network with a user, the user's device or desktop computer; the specifications of that device or desktop computer; the operating system of that device or desktop computer, and so forth. In the course of the User-Agent string, the information provided by the Proxy server's browser to a web page server enables the web page server, if it offers different versions for a given web page, to customize its content and adjust various features that make the navigation experience more suitable to the particular characteristics of the Proxy server's browser and the user's device.

Information sent to web page servers by the Proxy server's browser, most notably the components of User-Agent strings, can be altered. According to the prior art, the User-Agent strings that are communicated to web page servers during the user's navigation contain browser-identification components that typically either disclose true information about the browser or cloak and alter its actual identity for a single other browsing application. The browser-identification components affect the web navigation when the web page server offers different versions for a web page in accordance with different browsing applications.

However, many web page servers only offer adapted versions of their content to specific browsing applications, and it is possible that the Proxy server's browser does not identify itself as one of them. In addition, the browser identity that minimizes the amount of data transferred to the Portable Device may not be the same for different web pages. Yet, in some cases, the browser identity that leads to the least amount of data being sent from the Proxy server to the Portable Device has the disadvantage of not offering a satisfying navigation experience to the user, taking into consideration the Portable Device's characteristics. There is a need for a method that exploits more efficiently the potential of User-Agent strings in order to provide a better navigation experience to the user and to reduce bandwidth consumption with respect to data transferred from the Proxy server to the Portable Device.

Moreover, when executing a correlation analysis as described above, if blocks of data or parts of the snapshot image of the new or refreshed web page are the same as blocks of data or parts of the image stored into the Portable Device's and the Proxy server's cache memories, but located at different positions, the Proxy server's correlation analysis does not recognize that they are the same. In those instances, the Proxy server inefficiently, in both speed and bandwidth consumption, sends again these refreshed blocks of data to the Portable Device.

Furthermore, when additional content is requested for a web page, the web page server takes into account any modification or update that took place in higher portions of the refreshed web page to determine the content of the currently-requested portion of the web page. These changes include advertisement banners or other text or graphic elements that have been added, inserted as a response to user scrolling, deleted, modified (e.g., changed in size) or moved at another position in the web page hosted on the web page server between the moment a previous portion of the web page's content was transmitted to the Proxy server and the Portable Device, and stored in their cache memories, and the later instance an additional portion is called up. As a consequence of this refreshment, some blocks of data that were originally sent in a previous portion of the web page transmission may be sent anew in a subsequent one. Likewise, if the user scrolls back up to a portion of the web page that was previously viewed, the Proxy server's browser sends a request to the web page server for refreshed content to be sent for that portion of the web page. Therefore, every time a new portion of a web page is requested or a previously-viewed portion of a web page is refreshed, redundant or unneeded transfers of data between the Proxy server and the Portable Device are likely to happen, which in turn affect negatively the Portable Device's bandwidth consumption and speed performance.

### BRIEF SUMMARY OF THE INVENTION

This invention reduces the amount of data sent from a Proxy server to a Portable Device, thus conserving on bandwidth consumption, providing a faster display of web page images on the Portable Device's screen and allowing the commercial offer of more cost-competitive devices.

In accordance with the invention's principal embodiment, when a snapshot image is taken of a web page rendered onto a Proxy server's virtual display, and this snapshot image is divided into blocks or parts, the Proxy server calculates and ascribes for each block a specific identifier, such as, for reference purposes, a checksum. If and when blocks are sent to the Portable Device, their checksums are saved in a cache memory of the Portable Device, alongside data for blocks cached therein. Each block and their ascribed checksums are also stored into a location of the Proxy server's cache memory, where they are associated to their respective websites.

In this invention, the Proxy server uses blocks' computed checksums to determine its instructions to the Portable Device and the data that needs to be sent. After computing checksums for blocks of a web page image, the Proxy server compares these checksums with those stored in its cache memory for the website to which that web page belongs. If the just-computed checksum of a block is the same as a checksum stored into the Proxy server's cache memory for that web site, the Proxy Server does not send to the Portable Device the block that corresponds to the just-computed checksum. Instead, it instructs the Portable Device to copy the block with the same checksum from the corresponding web page image stored into the Portable Device's cache memory, and to display this block on the Portable Device's screen at the position it occupies in the web page image just loaded. For blocks of data whose checksums do not match the checksum of any block in the Proxy server's cached web page image, the Proxy server sends these new blocks and their checksums to the Portable Device.

The principal embodiment of this invention can also be executed when advertisement banners or other elements are inserted in the web page from the web page server as the user scrolls up, down or sideways. Should the virtual display of the Proxy server be thereafter refreshed while the user is still navigating on this web page, this insertion shifts the positions of all subsequent blocks of data in the refreshed web page. With this invention, blocks that have been previously sent and whose positions have only shifted would not be sent again from the Proxy server to the Portable Device since they would be ascribed the same checksum.

In alternate embodiments of the invention, the Proxy server does not store into its cache memory a mirror copy of web page images stored into the Portable Device's cache memory. Instead, it either only saves the checksums ascribed to blocks of data stored into the Portable Device's cache memory, or no information at all. When a new web page is loaded, or when the content of the currently-viewed web page is refreshed, the Proxy server compares checksums between, on the one hand, blocks of data associated to the web page image just loaded and, on the other hand, either checksums previously saved in the Proxy server's cache memory or checksums received from the Portable Device, depending on whether or not the Proxy server saves previously-computed checksums into a cache memory.

Further embodiments of the invention decrease the likelihood of cases in which new or refreshed portions of web pages are requested to a web page server, thereby reducing the amount of data transferred from the Proxy server to the Portable Device, conserving on bandwidth consumption and improving the Portable Device's performance.

The first of these embodiments is two-part. In its first half, the Proxy server simulates, for web page servers, a virtually-fabricated display screen whose dimensions are greater than those of the actual screen of the Portable Device. From there, every time a web page server transmits content information for a web page or for a portion of a web page to the Proxy server, more content is sent by the web page server and received by the Proxy server. This outcome reduces the likelihood that refreshed content is requested to a web page server by the Proxy server. The second half of this embodiment incorporates a particular prior art process of server operations, by which the Proxy server divides the virtual image of every web page portion received from a web page server into two or more sections. Next, the Proxy server takes a snapshot of each section of the web page image. Initially, the Proxy server only sends data or display instructions, or both, to the Portable Device regarding the first of these sections. For the other section(s), the Proxy server would send data or display instructions, or both, to the Portable Device only if the user shows intent of viewing one of those sections. With this process, only data for the first section is received by default by the Portable Device.

In a further embodiment of the invention, scrolling down or clicking somewhere that shifts the image display down to the images' limits no longer sends a signal from the Portable Device to the Proxy server to request for additional content for the web page from the web page server. Instead, when the Proxy server divides into sections the web page portions received from a web page server, it inserts a button at or near the bottom limit of every last section of a portion. This button indicates to the user that there exists more content for this web page, and that clicking on this button triggers additional content to be sent to the user. This button is copied in the snapshot image of the virtual image and then sent to the Portable Device alongside data for its corresponding section should this data be sent to the Portable Device. The Proxy server's browser sends a request for additional content to the web page server only if the user clicks on the button. Alternatively, the Proxy server's browser also sends a request for additional content to the web page server when the user shows intent of viewing the next portion.

Another embodiment of the invention discloses a method for selecting the browser-identification information that the Proxy server's browser communicates to web page servers in a way that further reduces the amount of data transferred to the Portable Device, yet still maintains a minimally-satisfying navigation experience to the user. This embodiment relies on a database constituted of the websites that are the most often requested and navigated to by typical users. For each of these websites, usability and data transfer performance are evaluated from the point of view of the user, with reference to a specific Portable Device and to each browsing application that the Proxy server's browser could potentially identify itself as. For each website that is considered popular enough to be inserted in the database, the server determines the browser-identification components that, once simulated, provide the best data transfer performance among those that are minimally satisfying for the user's navigation experience. In the database, the browsing application that achieves this optimal yet minimally-satisfying performance is assigned, on a case-by-case basis for each popular website therein. Thereafter, when the user requests a web page, the Proxy server's browser verifies if the website associated with that web page is listed in the database previously set up and saved in the Proxy server. If it is, the Proxy server's browser alters its browser-identification components for those that simulate the browsing application assigned to that website in the database

The above as well as additional features and advantages of the present invention will become apparent in the following written detailed description.

### BRIEF DESCRIPTION OF THE SEVERAL VIEWS OF THE DRAWINGS

The invention is described in more detail below with respect to an illustrative embodiment shown in the accompanying drawings in which:

FIG. 1 is a drawing illustrating the division of a web page image into blocks of data in accordance with the prior art.

FIG. 2 is a drawing illustrating the division of a web page image into blocks of data in accordance with this invention's preferred embodiment, in which the division is based on the HTML content of the associated web page.

FIGS. 3a & 3b are drawings illustrating data stored into cache memories of the Proxy server and the Portable Device, as well as a snapshot image of a corresponding web page that has just been called up, which exemplary snapshot image and stored data are used to determine the data and display instructions that would be sent from the Proxy server to the Portable Device, in accordance with both the prior art method and with this invention's principal embodiment.

FIGS. 4a & 4b are drawings illustrating data stored into cache memories of the Proxy server and the Portable Device, as well as a snapshot image of a corresponding web page that has just been refreshed, which exemplary snapshot image and stored data are used to determine the data and display instructions that would be sent from the Proxy server to the Portable Device, in accordance with both the prior art method and with this invention's principal embodiment.

FIG. 5a is a drawing illustrating the size of the image virtually displayed on the Proxy server by its browser, which size, in accordance with the prior art, is determined by the actual dimensions of the Portable Device's screen.

FIG. 5b is a drawing illustrating the size of the image virtually displayed on the Proxy server by its browser, which size, in accordance with this invention, is determined by simulated dimensions for the Portable Device's screen.

FIG. 6 is a drawing illustrating the division of a portion of a web page image into more than one section, which division is applied, in accordance with this invention, to both the image virtually displayed on the Proxy server by its browser and the snapshot image of this virtual display.

FIG. 7 is a drawing illustrating the request and display of additional portions of a web page in accordance with this invention.

FIG. 8 is a table illustrating a fictitious example assessing usability and ordering data transfer performance for four different browsers with respect to the yahoo.com web site.

FIG. 9 is a table illustrating a fictitious example assessing usability and ordering data transfer performance for four different browsers with respect to the google.com website.

FIG. 10 is a table illustrating a fictitious example assessing usability and ordering data transfer performance for four different browsers with respect to the cnn.com website.

FIG. 11 is a table illustrating a database created in accordance with this invention whereby popular websites are each assigned a specific browser identity in accordance with this invention's previous assessments of usability and data transfer performance.

Where used in the various figures of the drawings, the same numerals designate the same or similar parts.

### DETAILED DESCRIPTION OF THE INVENTION

For reference purposes, it is hereinafter assumed that the internal memory that is mostly relied on by the Proxy server and the Portable Device in this invention's various embodiments is cache memory, although flash memory could alternatively be used.

A Portable Device's cache memory is different from its display memory, a memory location in the Portable Device where pixels and data for an image are temporarily stored into a decompressed, bitmap format, from which a part is currently displayed on the Portable Device's screen. In this invention's preferred embodiments, web page images are displayed from the display memory location.

### Prior Art Inefficiencies

According to the prior art, when a Proxy server compares which blocks of data or parts of a web page image are exactly the same between a snapshot image of a refreshed web page just received from a web page server and an image of that same web page stored into the Portable Device's and the Proxy server's cache memories, a correlation analysis is performed by the Proxy server to check if data has been updated. This correlation analysis only compares blocks or parts of the image located at the same position on both versions of the web page image. If blocks of data or parts of the snapshot image of the refreshed web page are the same as blocks of data or parts of the image stored into the Portable Device's and the Proxy server's cache memories, but located at different positions, the Proxy server's correlation analysis does not recognize that they are the same.

In those instances, the Proxy server inefficiently, in both speed and bandwidth consumption, sends again these refreshed blocks of data to the Portable Device, in a compressed format. These suboptimal transfers of data can occur in various circumstances, including because advertisement banners or other text or graphic elements have been added, deleted, modified (e.g., changed in size) or moved at another position in the web page in the web page server between the moment said web page was first stored into the Portable Device's and the Proxy server's cache memories and the instance it is called up, at a later time. This inefficient situation also occurs when advertisement banners or other text or graphic elements are inserted in the web page in the web page server as the user scrolls up, down or sideways; should the Proxy server thereafter refresh its browser's virtual display while the user is still navigating on this web page, this insertion shifts the position of all subsequent blocks of data in the refreshed web page. By addressing the inefficient transfers of data that ensue from these circumstances, the method disclosed in this invention's principal embodiment reduces the amount of data transferred from the Proxy server to the Portable Device, thereby conserving on the bandwidth consumed, providing a faster display of web page images on the Portable Device's screen and allowing the commercial offer of more cost-competitive devices. Both situations, calling up a web page already stored into the Portable Device's and the Proxy server's cache memories and the refreshment of a web page currently navigated by the user, are covered below with detailed examples of the principal embodiment of this invention, as well as alternate embodiments. Nonetheless, the general description of the principal embodiment of this invention is made with reference to calling up a web page already stored into the Portable Device's and the Proxy server's cache memories.

Principal Embodiment—General Description

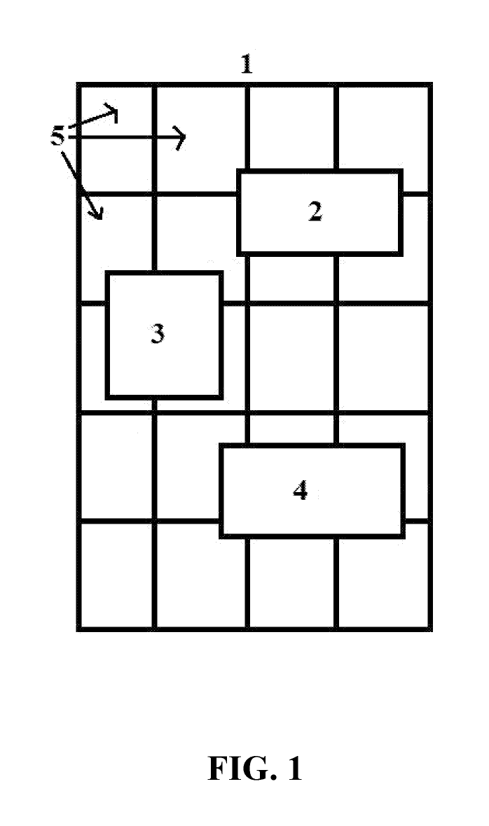

The prior art discloses numerous processes by which a Proxy server can divide a web page image into blocks before sending data, if any, to a remote device. In the multi-step process of the prior art that is the closest to this invention's preferred embodiment, the Proxy server begins by differentiating graphic elements, primarily pictures, from non-graphic elements, usually constituted of text. One way through which the Proxy server can achieve this differentiation is by analyzing the HTML content and elements that the Proxy server's browser receives from the web page server for a web page. From then on, the Proxy server treats each graphic element as a single block of data, while other, non-graphic areas of the web page image are divided into blocks using a matrix grid overlying the web page image but underlying the areas of graphic elements. As an example, the image 1 of a web page currently viewed is represented in FIG. 1. In this image, the Proxy server recognizes areas 2, 3 & 4 as graphic elements, and it treats each of these areas as a separate block of data. Next, the Proxy server divides the rest of the page with a matrix grid and considers each area resulting from this matrix grid delineation—some of which are indicated by 5—as a separate block of data.

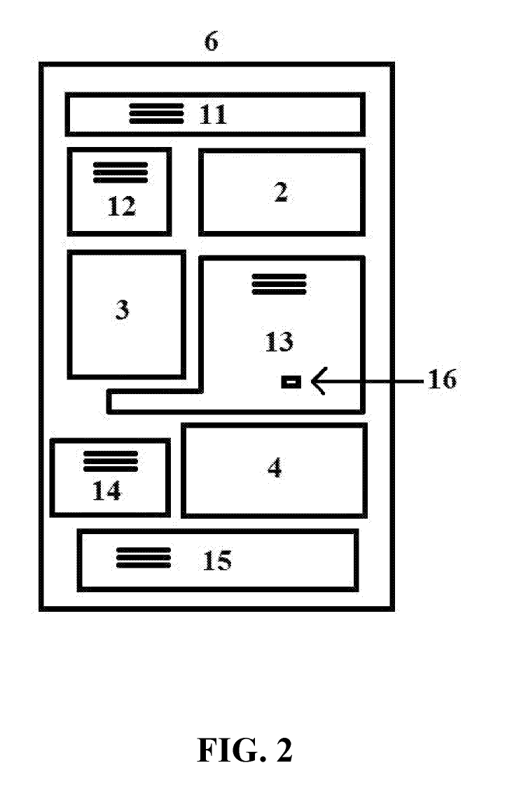

In this invention's preferred embodiment, graphic elements are constituted as separate blocks at the outset, in the same fashion as in the prior art just described above. Non-graphic areas of a web page image, however, are not divided by relying on a matrix grid. Instead, the Proxy server analyzes the last-child elements of HTML that visually affect the rendering of the web page, the Proxy server's browser receiving this HTML content for the web page from the web page server in accordance with the prior art. Some of these last-child elements of HTML that visually affect the rendering of the web page can be quite large, such as entire paragraphs, whereas others can be considerably smaller, like changes in font styles or sizes, multiple print colors, text subdivisions, a quote element or a hyperlink inserted within a larger textual element, and so forth. On the one hand, the larger a non-graphic block of data is, the more susceptible it is to be modified over time. As a result, when a large block of data of a non-graphic element is stored into the Portable Device's and the Proxy server's cache memories, it is less likely than smaller blocks to be efficiently reused for display at a later stage. On the other hand, the blocks of data that are stored in the Portable Device's and Proxy server's cache memories are compressed beforehand, and the compression quality of small blocks is poorer than for larger blocks. In its analysis of last-child elements of HTML for the division of non-graphic blocks of data, the Proxy server takes these two factors into account, on the basis of predetermined thresholds. If the Proxy server assesses that the block of data corresponding strictly to a last-child element of HTML would be too small, the Proxy server concatenates it with one or many adjacent element(s) to constitute a single block of data. However, the Proxy server subdivides elements that, because of their large size, are considered too likely to be modified over time, an event that makes useless their storage into cache memory. An example of this preferred division process is outlined with reference to FIG. 2. For this web page image 6, the Proxy server first recognizes areas 2, 3 & 4 as graphic elements and constitutes them as separate blocks. Shortly after, the Proxy server identifies display areas 11, 12, 13, 14 & 15 as elements of HTML that visually affect rendering and that will be constituted into blocks. For the purpose of this example, these blocks may respectively be a heading (11), a caption (12) for the picture in area 2, a first paragraph (13) in the body of the page, a second paragraph (14) and a footer (15). With respect to paragraph 13, the Proxy server is aware that it contains a further child 16, in this example, a word whose font is different than the font of the rest of the paragraph. However, the Proxy server's predetermined threshold assesses that, should this last-child element 16 be constituted as a block of its own, it would be too small for its compression to be satisfying, so it is concatenated to the rest of its surrounding paragraph to together constitute block 13.

In accordance with the invention's principal embodiment, when blocks or parts of a web page image are loaded in the Proxy server's virtual display, the Proxy server ascribes to each block of data an identifier which can be a string of numbers, alphabet letters, symbols, or any combination thereof. If and when blocks of data are sent to the Portable Device, in application of this invention's method as described below, these identifiers are also saved in the Portable Device alongside data for blocks cached therein. Since these blocks are later stored into the Proxy server's cache memory as a mirror of the Portable Device's cache memory, as required in the processes of both the prior art and this invention's principal embodiment, each block's ascribed identifier is consequently also stored into the Proxy server's cache memory. To compute and assign a block's identifier, the Proxy server uses, and only uses, values representing content information for that block of data, for instance, its height, its width, its object (text, graphic element, animation or moving part, etc.), its HTML elements, its pixel colors, its pixel configuration, and so forth, or any combination of these content information values. More specifically, content information for the blocks of data does not take into account information such as a block's position in the web page image or its arrangement in relation with other blocks of data. No matter the particular computation method used to ascribe each block's identifier and the particular content information values taken into account, this computation must have two sets of characteristics. First, it should be detailed and specific, so that it is highly unlikely, or impossible, for blocks of data with different content to share the same identifier. Second, the computation should be sufficiently systematic and consistent for blocks sharing the same content to generally be ascribed the same identifier. One example of a computation method that would possess these characteristics is an algorithm that, for each block, recognizes and integrates in the block's resulting identifier the colour of every pixel from left to right and across rows. Another example of a computation method that typically possesses these two sets of characteristics is a checksum algorithm. For reference purposes, the preferred computation method relied on in this invention's various embodiments, including in their accompanying examples herein, is a checksum.

As described above and in the prior art, a web page image stored into the Portable Device's and the Proxy server's cache memories may not look exactly as the actual web page at different times, since most web pages are modified or updated over time. In the prior art, the Proxy server uses a correlation analysis based on blocks' positions to establish its instructions to the Portable Device and identify the data that should be sent thereto. According to the present invention, the Proxy server rather uses blocks' computed checksums to determine its instructions to the Portable Device and the data that needs to be sent.

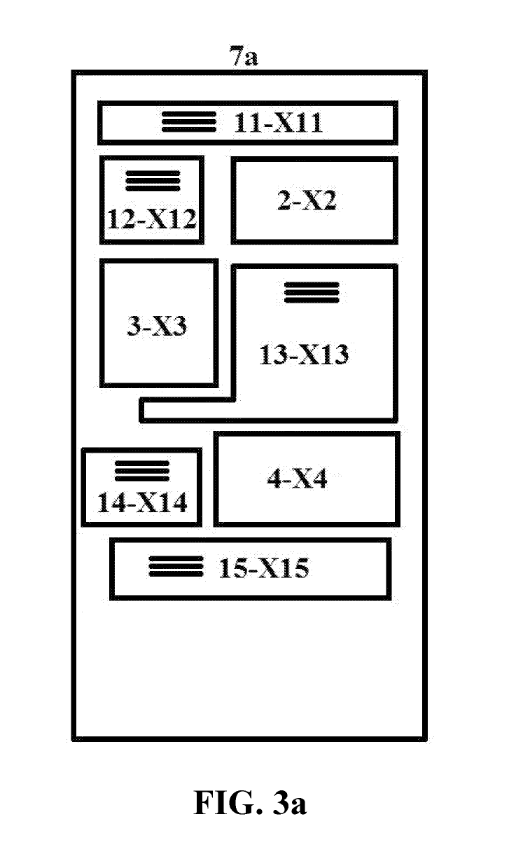

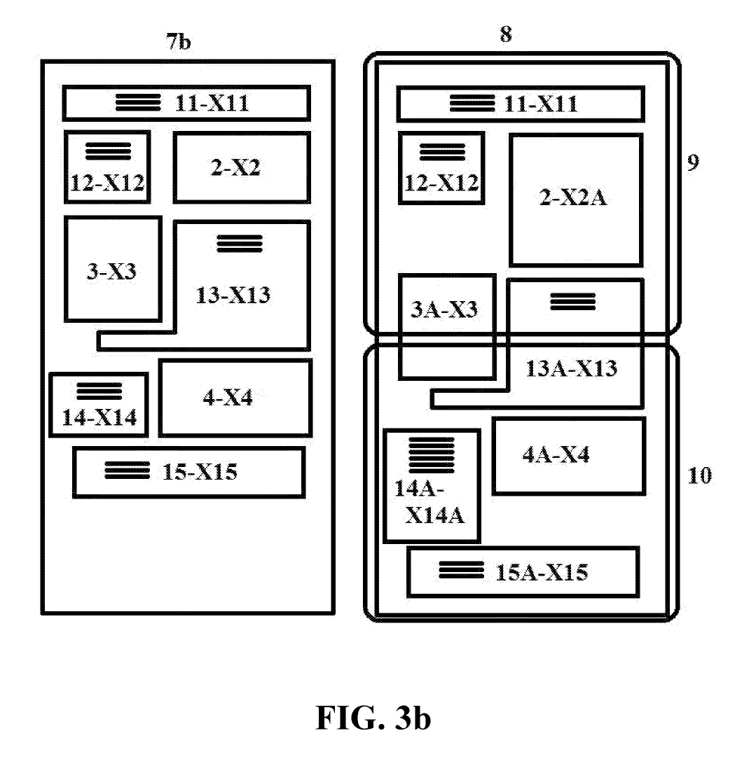

Thus, with further reference to FIG. 3a and FIG. 3b as one illustration of the invention's principal embodiment, a web page image cached into the Portable Device 7a and the

Proxy server 7b contains compressed data that was sent for that particular web page during a previous viewing. Said blocks of data 2-X2, 3-X3, 4-X4, 11-X11, 12-X12, 13-X13, 14-X14 & 15-X15 in FIG. 3a and FIG. 3b are referred to in conjunction with both their positions, as established in the prior art, and their computed checksums, as articulated in this invention's principal embodiment. Hence, in the images 7a & 7b stored into the Portable Device's and the Proxy server's cache memories, the numbers 2, 3, 4, 11, 12, 13, 14 & 15 on the left-hand side of the hyphens indicate the blocks' positions on the cached web page images 7a & 7b, while the alphanumeric codes X2, X3, X4, X11, X12, X13, X14 & X15 on the right-hand side of the hyphens represent these same blocks' respective checksums.

When web navigation by the user leads to a web page, either because the user clicks on the back or forward buttons on the Portable Device, types in a web page's URL or clicks on a link to a web page, the Proxy server's browser receives HTML, JAVA, JPEG or other types of information and loads a fresh portion of the web page from the web page server, which portion is rendered completely by the browser on the Proxy server's virtual display. Then, as described in the prior art, a single frozen image frame or snapshot 8 is taken by the Proxy server whereby no pixels change in this frame. In accordance with the present invention, the Proxy server divides this snapshot image 8 of the currently-viewed web page into blocks of data in the preferred manner disclosed above. Immediately after, it computes a checksum for each block of data contained in the current viewable area of the Portable Device's display screen in the snapshot image 8 by relying on the same algorithm used to ascribe checksums to blocks of web page images stored into the Portable Device's and the Proxy server's cache memories. When the web page is first loaded, this current viewable area is the initial display area 9. Shortly afterward, the Proxy server verifies whether a web page image of this currently-viewed web page is stored into the Portable Device's cache memory, mirrored into the Proxy server's cache memory. In one prior art method, the Proxy server makes this verification by checking for the same URL as the currently-viewed web page in the URLs of web page images stored into the Portable Device's and the Proxy server's cache memories. In this invention, the Proxy server checks instead if any stored web page associated with the web site of the currently-viewed web page contains a block whose ascribed checksum is the same as one of the checksums just computed for the blocks positioned in the initial viewable area 9 of the snapshot image 8. This way, the Proxy server takes advantages of the saved checksums of this invention by being able to recognize previously-viewed web pages even though their URLs might have changed within a same domain.

If no web page image associated with the current web page is stored into the Portable Device's and the Proxy server's cache memories, the Proxy server compresses the blocks of data just divided, and thereupon sends this data—including blocks' ascribed checksums—to the Portable Device. Unless the user scrolls to another area of the web page, the transfer of data begins with the blocks occupying the initial viewable area on the display screen of the Portable Device 9 so that an initial display result for the user's web navigation request can be viewed as quickly as possible. The Proxy server's subsequent actions regarding data transfer depend on its preset or user-adjusted order of priority, as described in the prior art or further below in other embodiments of this invention.

If a web page image associated to the currently-viewed web page is already stored into the Portable Device's cache memory, which for the sake of this example is the case with image 7a, the Proxy server retrieves a copy of its corresponding web page image 7b, stored into the Proxy server's cache memory, for the purpose of comparing it with the new snapshot image 8 of that web page. For this example, as can be observed in FIG. 3b, several modifications have been brought in this web page between the moment it was stored into the Portable Device's and the Proxy server's cache memories and the current, updated version. Position and content changes are denoted by the addition of A in a block's position number or ascribed checksum, or both, depending on the nature of the changes for each block. Namely, the graphic element block 2-X2A is different and larger than its previous version 2-X2; text has been added in the non-graphic block 14A-X14A in comparison with its previous version 14-X14; and the enlargements of blocks 2-X2A & 14A-X14A shifted the positions of every block located below them in the web page. In application of the prior art method, to determine the instructions and data that the Proxy server sends to the Portable Device, the Proxy server performs a correlation analysis between the versions 7b & 8 of the web page image, which analysis is based on the blocks' positions and their respective contents. In accordance with the invention, the Proxy server rather executes a comparative analysis of blocks' checksums. As blocks 2-X2A & 14A-X14A are the only elements whose content has actually been modified, they are the only blocks whose computed checksums have changed.

Thus the Proxy server has first computed a checksum for blocks with position identities 11, 12, 2, 3A & 13A in the initial display area 9 of the snapshot image 8. For this example, these blocks' respective computed checksums are X11, X12, X2A, X3 & X13. After finding out that the web page image 7b stored into its own cache memory contains at least one block of data to which one of these checksums is ascribed, the Proxy server retrieves this web page image. Second, for that web page, the Proxy server compares the just computed checksums of the initial display area 9 of the snapshot image 8, for each block at a time in sequence, with the checksums of blocks anywhere in the web page image 7b. When, with this comparison, the Proxy server is informed that blocks contained in the current viewable area of the Portable Device's display screen in the snapshot image 8 have the same checksums as blocks in the cached web page image 7b, the Proxy server instructs the Portable Device, in the following order, to copy those blocks from the web page image 7a stored into the device's cache memory; decompress them; store them into the Portable Device's display memory and assemble them on the basis of their position coordinates in the snapshot image 8 which coordinates are sent from the Proxy server to the Portable Device along with the Proxy server's instructions; display them on the Portable Device's screen from the display memory location, and store the new positions for these blocks into the Portable Device's cache memory for that web page. Third, for blocks contained in the current viewable area of the Portable Device's display screen in the snapshot image 8 whose checksums do not match the checksum of any block in the cached web page image 7b, the Proxy server compresses these new blocks of data and sends them to the Portable Device, which decompresses them; stores them in the correct location into its display memory; displays them on its screen from the display memory location, and stores them into its cache memory for the web page. Last, the Proxy server stores into its cache memory for that web page a copy of all the blocks just stored into the Portable Device's cache memory and the new coordinates of blocks that changed positions.

In the following detailed example, the results of the prior art process are contrasted with those of this invention's principal embodiment for a previously-viewed web page. Another detailed example comes next, this one applying the principal embodiment to a web page refreshed during the user's navigation of that web page. These examples show that, when the Proxy server applies this invention as disclosed in its principal embodiment instead of prior art methods, it does not need to send data over again to the Portable Device regarding blocks previously stored into the Portable Device's and the Proxy server's cache memories and that have simply shifted to another position in the new or refreshed web page.

### Principal Embodiment—Calling up a Web Page Already Stored into the Portable Device, Initial Viewable Area

For the first of these examples, illustrated in FIG. 3a and FIG. 3b, had the Proxy server applied the prior art method of correlation analysis, it would have been aware that data for the initial display area 9 of the Portable Device had been sent to the Portable Device in a previous viewing of that web page. Performing its correlation analysis in order to check whether this data has been modified or not over time, the Proxy server would have recognized that blocks 11-X11 & 12-X12 of the snapshot image 8 of the currently-viewed web page are the same as their corresponding blocks in the web page image 7b stored into the Proxy server's cache memory. However, the Proxy server would have found that blocks 2-X2A, 3A-X3 & 13A-X13 in the snapshot image 8 do not correlate with their respective counterparts in the web page image 7b stored into the Proxy server's cache memory. Based on this analysis, the Proxy server would have instructed the Portable Device to copy blocks 11-X11 & 12-X12 from the Portable Device's stored image 7a of that web page in the Portable Device's cache memory; decompress them; store them at their correct location into the Portable Device's display memory, and display them from the display memory location on the Portable Device's screen at the same positions. Shortly after, the Proxy server would have sent to the Portable Device compressed data for blocks 2-X2A, 3A-X3 & 13A-X13 of the snapshot image 8 with instructions to decompress these blocks; store them at their correct location into the Portable Device's display memory; display them on the Portable Device's screen from the display memory location, and store them into the Portable Device's cache memory for that web page. The Proxy server would also have stored into its own cache memory an updated mirror image of the Portable Device's cached data for that web page.

In application of the comparative analysis of blocks' checksums disclosed in this invention, the Proxy server also recognizes that it previously sent data to the Portable Device for this web page. For blocks occupying the initial display area 9 of the snapshot image 8 of the currently-viewed web page, the Proxy server compares the computed checksum results with those in blocks contained anywhere in the Proxy server's cached image 7b of the web page. Having the same checksums, blocks 11-X11, 12-X12, 3A-X3 & 13A-X13 of the snapshot image 8 are found to be respectively the same as blocks 11-X11, 12-X12, 3-X3 & 13-X13 in the Proxy server's cached web page image 7b. Therefore, the Proxy server instructs the Portable Device, in the following order, to copy blocks 11-X11, 12-X12, 3-X3 & 13-X13 from the Portable Device's cached image 7a of that web page; decompress them; store them into the Portable Device's display memory and assemble them respectively in the same positions as blocks 11-X11, 12-X12, 3A-X3 & 13A-X13 in the snapshot image 8 whose coordinates are sent from the Proxy server to the Portable Device along with these instructions; display them on the Portable Device's screen from the display memory location, and store these blocks' new positions into the Portable Device's cache memory for that web page. Immediately after, since block 2-X2A′s checksum is different from the checksums of any block stored into the Proxy server's image 7b of the web page, the Proxy server sends to the Portable Device compressed data for this block with instructions to decompress it; store it into the Portable Device's display memory in the same position as in the snapshot image 8; display it on the Portable Device's screen from the display memory location, and store it into the Portable Device's cache memory for that web page. Subsequently, the Proxy server stores into its own cache memory for that web page a copy of the new block of data just stored into the Portable Device's cache memory and the new coordinates of blocks that changed positions.

In this example, instead of the Proxy server sending data for blocks 3A-X3 & 13A-X13 to the Portable Device as would have been the case with the prior art process, the Proxy server only sends to the Portable Device instructions to copy blocks 3-X3 & 13-X13 from its web page image 7a already stored into cache memory. As exemplified here, the present invention allows a new version of a previously-viewed web page stored into the Portable Device's cache memory to be displayed without having to send as much data as would have been necessary by relying strictly on prior art.

### Principal Embodiment—Calling up a Web Page Already Stored into the Portable Device, New Viewable Area

Thereafter, as explained in the prior art, the Proxy server executes operations based on its preset or user-adjusted order of priority. The standard second priority consists in the Proxy server sending in the same manner data to the Portable Device whereby a small field around the displayable area of the Portable Device is filled up with blocks of data. These second-priority operations are only executed once the first priority, sending blocks of data for the current viewable area of the Portable Device's display screen, is completed. Those second-priority operations, as well as subsequent options of priority order disclosed in the prior art, determine which parts of the rest of the snapshot image 8 of the currently-viewed web page are checked in order to fill in the Portable Device's display and cache memories for the rest of the refreshed web page image. If a part is filled this way, and the user scrolls over it, it is ready to be instantly displayed from the display memory.

In any case, if the user clicks somewhere or scrolls up, down or sideways in a way that changes the Portable Device's display area on the snapshot image 8 to a new viewable area that the Proxy server has not yet checked, this command is instantaneously communicated to the Proxy server. If the Proxy server is operating in accordance with the invention's principal embodiment, it thereupon computes checksums for blocks in that new display area. Then, the Proxy server performs a comparison of the resulting checksums ascribed to blocks located in that new display area of the currently-viewed web page with those of blocks of data located anywhere in the corresponding web page image 7b stored into the Proxy server's cache memory. A case of this instance, in which the results are also compared with those of prior art operations, is illustrated in FIG. 3a and FIG. 3b. It is therein assumed that the Proxy server sent data and instructions to the Portable Device in the manner described above regarding area 9 of the snapshot image 8, after which the user scrolls down to a lower area 10. The Proxy server notices that blocks 3A-X3 & 13A-X13 have been processed in the previous sequence, so it is only concerned with the newly displayed blocks of data in area 10.

Had the Proxy server applied the prior art method of correlation analysis, it would have found that blocks 4A-X4 & 14A-X14A of the snapshot image 8 of the currently-viewed web page differ from blocks located in their corresponding positions in the web page image 7b stored into the Proxy server's cache memory. Regarding block 15A-X15, the Proxy server would have been unaware of any data being previously sent to the Portable Device for this space. Hence, it would not have performed any correlation analysis for block 15A-X15. Accordingly, the Proxy server would have sent to the Portable Device compressed data for these three blocks from the snapshot image 8 with instructions to decompress them; store them into the Portable Device's display memory at their correct location; display them on the Portable Device's screen from the display memory location, and store them into the Portable Device's cache memory for that web page. The Proxy server would then have stored into its own cache memory an updated mirror image of the Portable Device's cached data for that web page.

In application of this invention's principal embodiment, when the user scrolls to area 10 of the snapshot image 8 of the currently-viewed web page, the Proxy server's first response is to compute checksums for the blocks in that area with position identities 4A, 14A & 15A. In this example, those computed checksums are respectively X4, X14A & X15. Next, the Proxy server compares these checksums with those of any block in the web page image 7b previously stored into and retrieved from the Proxy server's cache memory. With this comparative analysis of blocks' checksums, the Proxy server establishes that it has already sent data to the Portable Device for blocks 4A-X4 & 15A-X15 in the snapshot image 8, which respectively have the same checksums as blocks 4-X4 & 15-X15 in the Proxy server's cached web page image 7b. Therefore, the Proxy server instructs the Portable Device, in the following order, to copy blocks 4-X4 & 15-X15 from the Portable Device's cached image 7a of that web page; decompress them; store them into the Portable Device's display memory and assemble them in the positions respectively occupied by blocks 4A-X4 & 15A-X15 in the snapshot image 8 whose coordinates are sent by the Proxy server to the Portable Device along with these instructions; display them on the Portable Device's screen from the display memory location, and store these blocks' new positions into the Portable Device's cache memory for that web page. Immediately after, discovering that block 14A-X14A's checksum differs from every checksum computed in blocks cached in the Proxy server's web page image 7b, the Proxy server sends compressed data for this block to the Portable Device with instructions to decompress this block; store it into the Portable Device's display memory in the same position as in the snapshot image 8; display it on the Portable Device's screen from the display memory location, and store it into the Portable Device's cache memory for that web page. Subsequently, the Proxy server stores into its own cache memory for that web page a copy of the new block of data just stored into the Portable Device's cache memory and the new coordinates of blocks that changed positions.

In this example, instead of the Proxy server sending data for blocks 4A-X4 & 15A-X15 to the Portable Device as would have been the case with the prior art method, the Proxy server only sends to the Portable Device instructions to respectively copy blocks 4-X4 & 15-X15 from its web page image 7a already stored into cache memory. As exemplified here too, the principal embodiment of the present invention allows an updated version of a previously-viewed web page stored into the Portable Device's cache memory to be displayed without having to send as much data as would have been necessary by relying strictly on prior art. In particular, as demonstrated by block 15A-X15 of this example, it is possible with this invention that the Proxy server will not need to send data to the Portable Device for a viewable area that had yet not been viewed by the user.

### Alternate Embodiment—Calling up a Web Page Already Stored into the Portable Device

In an alternate embodiment of this invention, after dividing the snapshot image 8 of the currently-viewed web page into blocks of data in the preferred manner disclosed above, the Proxy server computes checksums for every block of data in the snapshot image 8 of the currently-viewed web page (instead of only for those blocks that are contained in the current viewable area of the Portable Device's display screen in the snapshot image 8). These checksums are computed by relying on the same algorithm used to ascribe checksums to blocks of web page images stored into the Portable Device's and the Proxy server's cache memories. Subsequently, the Proxy server verifies whether a web page image of this currently-viewed web page is stored into the Portable Device's cache memory, mirrored into the Proxy server's cache memory, by checking if any stored web page associated with the website of the currently-viewed web page contains a block whose ascribed checksum is the same as one of the checksums just computed for the blocks in the snapshot image 8 of the currently-viewed web page (instead of only for those blocks that are contained in the current viewable area of the Portable Device's display screen in the snapshot image 8). For reference purposes, the Proxy server finds that it is the case with the Portable Device's web page image 7a, and the Proxy server retrieves a copy of its corresponding web page image 7b, stored into its cache memory, for the purpose of comparing this stored web page image 7b with the new snapshot image 8 of that web page.

Then, the Proxy server compares these checksums, for each block at a time in sequence, with the checksums of blocks anywhere in the web page image 7b previously stored into and retrieved from the Proxy server's cache memory. When, with this comparison, the Proxy server is informed that blocks contained anywhere in the snapshot image 8 (instead of only in the current viewable area of the Portable Device's display screen in the snapshot image 8) have the same checksums as blocks in the cached web page image 7b, the Proxy server instructs the Portable Device, in the following order, to copy those blocks from the web page image 7a stored into the device's cache memory; decompress them; store them into the Portable Device's display memory and assemble them on the basis of their position coordinates in the snapshot image 8 which coordinates are sent from the Proxy server to the Portable Device along with the Proxy server's instructions; if some of those blocks are positioned in the current viewable area of the Portable Device's display screen in the snapshot image 8, display them on the Portable Device's screen from the display memory location; and store these blocks' new positions into the Portable Device's cache memory for that web page. Applied to the previous example illustrated by FIG. 3a and FIG. 3b, the Proxy server would respond to this previously-viewed web page being loaded by communicating to the Portable Device display instructions as detailed in that example regarding blocks 11-X11, 12-X12, 3-X3, 13-X13, 4-X4 & 15-X15 saved in the Portable Device's cached web page image 7a. The subsequent operations, starting with the Proxy server sending compressed data to the Portable Device for new or modified blocks contained in the current viewable area of the Portable Device's display screen in the snapshot image 8, are then executed as detailed above in the principal embodiment of this invention, except for the following two improvements resulting from this embodiment. First, if some blocks located elsewhere than in the current viewable area of the Portable Device's display screen in the snapshot image 8 are copied in the manner described in this embodiment, they are ready to be instantly displayed on the Portable Device's screen from the display memory should the user scroll over them. Second, as the Proxy server in this embodiment no longer needs to compute and compare checksums when the user scrolls over to a new viewable area in the snapshot image 8, it can immediately respond to a scrolling command by sending compressed data for new or modified blocks, if any, contained in the new viewable area of the Portable Device's display screen in the snapshot image 8.

### Principal Embodiment—Refreshment in which Blocks Have Shifted

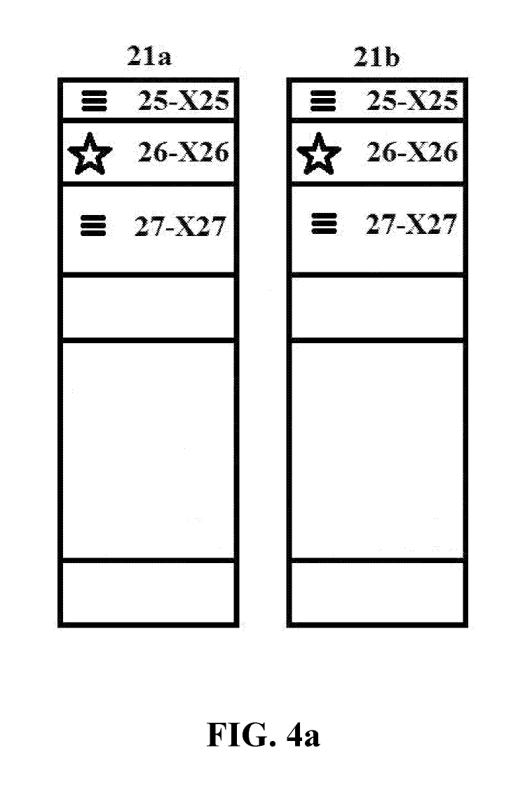

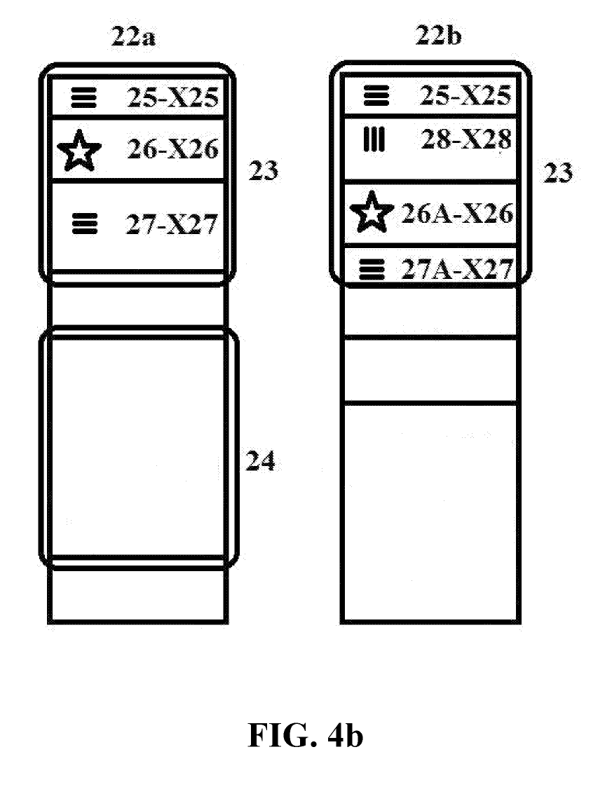

As mentioned earlier, the principal embodiment of this invention can also be executed when advertisement banners or other graphic or non-graphic elements are inserted in the web page in the web page server as the user scrolls up, down or sideways, which insertion, should the Proxy server thereafter refresh its virtual display while the user is still navigating on this web page, shifts the positions of all subsequent blocks of data in the refreshed web page. With references to FIG. 4a and FIG. 4b, the following detailed example applies the principal embodiment to these situations.

In this example, a web page was requested by the user and loaded onto the Proxy server. The Proxy server's browser displayed a virtual image of that web page onto the Proxy server, and the Proxy server took a single frozen image frame or snapshot 22a whereby no pixels changed in this frame. The Proxy server thereafter divided this image into separate blocks of data in the preferred manner described above using HTML content, and it calculated checksums for blocks of data located in the initial viewable area of the display area 23 of the snapshot image 22a. Three blocks of data were identified in this way: 25-X25, 26-X26 & 27-X27. (Reference characters for blocks of data in this example rely on the structure used in the previous example, with numbers on the left-hand side of hyphens indicating blocks' positions; alphanumeric codes on the right-hand side of hyphens indicating blocks' computed and ascribed checksums, and the capital letter A denoting a change in the position or computed checksum of a particular block.) In the manner disclosed above, the Proxy server sent to the Portable Device display instructions or data, or both, with respect to these blocks of data. Within this process, these blocks were stored, in a compressed format and with their corresponding positions, into the Portable Device's and the Proxy server's cache memories respectively as web page images 21a & 21b in FIG. 4a. Later, the user scrolled down so that the Portable Device's display area moved over to a new viewable area 24 in the snapshot image 22a, for which the previous steps for display instructions of data transfer have been reproduced (but whose details are irrelevant for this example).

As the user scrolls back up at the initial viewable area 23 of this same web page, refreshed content for this web page is received by the Proxy server as explained in greater detail in a further embodiment of this invention, an image of which is displayed onto the Proxy server by its browser. As a response to the user scrolling back up, a new element—an advertisement banner—was inserted in the web page at position 28, which added advertisement shifted the position of every block of data below it in the refreshed web page virtually displayed in the Proxy server. Shortly afterward, the Proxy server takes a single frozen image frame or snapshot 22b of this refreshed web page image whereby no pixels change in this frame. The Proxy server then determines the display instructions and data that it must send to the Portable Device regarding blocks of data positioned in the current viewable area 23 of the display area in the refreshed snapshot image 22b, the results of which when relying on the principal embodiment of this invention are compared with the prior art method.

In application of the prior art method of correlation analysis, performed with respect to blocks' positions and their respective content, the Proxy server would recognize that block 25-X25 of the refreshed snapshot image 22b is the same as block 25-X25 in the web page image 21b stored into the Proxy server's cache memory. For blocks 28-X28, 26A-X26 & 27A-X27 of the current viewable area of the display area in the refreshed snapshot image 22b, the Proxy server would find that they do not correlate with blocks in their respective positions in the web page image 21b stored into the Proxy server's cache memory. More particularly, the Proxy server does not recognize that blocks 26-X26 & 27-X27 in the web page image 21b stored into the Proxy server's cache memory have simply shifted into the blocks positioned at 26A & 27A in the refreshed snapshot image 22b. Based on this analysis, the Proxy server would instruct the Portable Device to copy block 25-X25 from the Portable Device's stored image 21a of that web page in its cache memory; decompress it; store it at its correct location into the Portable Device's display memory, and display the block from the display memory location on the Portable Device's screen at the same position. Subsequently, the Proxy server would send to the Portable Device compressed data for blocks 28-X28, 26A-X26 & 27A-X27 of the refreshed snapshot image 22b with instructions to decompress these blocks; store them at their correct location into the Portable Device's display memory; display them on the Portable Device's screen from the display memory location, and store them into the Portable Device's cache memory for that web page. The Proxy server would also store into its own cache memory an updated mirror image of the Portable Device's cached data for that refreshed web page image.

In application of the checksum comparative analysis included in this invention's preferred embodiment, the Proxy server first computes a checksum for each block of data contained in the current viewable area 23 of the Portable Device's display screen in the refreshed snapshot image 22b. It does so by relying on the same algorithm used to ascribe checksums to blocks of web page images stored into the Portable Device's and the Proxy server's cache memories. Thus the Proxy server computes a checksum for blocks with position identities 25, 28, 26A & 27A in the initial display area 23 of the refreshed snapshot image 22b. For this example, these blocks' respective computed checksums are X25, X28, X26 & X27. Second, the Proxy server compares these checksums, for each block at a time in sequence, with the checksums of blocks anywhere in the web page image 21b previously stored into the Proxy server's cache memory. This way, the Proxy server recognizes that it has already sent data to the Portable Device for the current viewable area of the Portable Device's display area: blocks 25-X25, 26A-X26 & 27A-X27 of the refreshed snapshot image 22b are found to be respectively the same as blocks 25-X25, 26-X26 & 27-X27 in the Proxy server's cached web page image 21b. Therefore, the Proxy server instructs the Portable Device, in the following order, to copy blocks 25-X25, 26-X26 & 27-X27 from the Portable Device's cached image 21a; decompress them; store them into the Portable Device's display memory and assemble them respectively in the same positions as blocks 25-X25, 26A-X26 & 27A-X27 in the refreshed snapshot image 22b whose coordinates are sent from the Proxy server to the Portable Device along with these instructions; display them on the Portable Device's screen from the display memory location, and store these blocks' new positions into the Portable Device's cache memory for that web page. Immediately after, since block 28-X28's checksum is different from the checksums of any block stored into the Proxy server's image 21b of the web page, the Proxy server sends to the Portable Device compressed data for this block with instructions to decompress it; store it into the Portable Device's display memory in the same position as in the refreshed snapshot image 22b; display it on the Portable Device's screen from the display memory location, and store it into the Portable Device's cache memory for that web page. Last, the Proxy server stores into its own cache memory for that web page a copy of the new block of data just stored into the Portable Device's cache memory and the new coordinates of blocks that changed positions.

In this example, instead of the Proxy server sending data for blocks 26A-X26 & 27A-X27 to the Portable Device as would have been the case with the prior art process, the Proxy server only sends to the Portable Device instructions to copy blocks 26-X26 & 27-X27 from its web page image 21a already stored into cache memory. As exemplified here, the present invention allows a refreshed version of a web page stored into the Portable Device's cache memory to be displayed without having to send as much data as would have been necessary by relying strictly on prior art.

### Alternate Embodiment—User Scrolling Refreshment in which Blocks Have Shifted

The alternate embodiment described above for the invention whereby, prior to sending any data for a web page image, the Proxy server initially computes checksums and performs a comparative checksum analysis for blocks located anywhere in a just loaded web page image (instead of only for the initial viewable area of the display area), can be translated to situations where a currently-navigated web page is refreshed. In this case, the moment the Proxy server receives refreshed content for the web page that is currently being displayed on the Portable Device, the Proxy server computes checksums for every block of data in the refreshed snapshot image 22b of the refreshed web page (instead of only for those blocks that are contained in the current viewable area 23 of the Portable Device's display screen in the refreshed snapshot image 22b). These checksums are computed by relying on the same algorithm used to ascribe checksums to blocks of web page images stored into the Portable Device's and the Proxy server's cache memories. Then, the Proxy server compares these checksums, for each block at a time in sequence, with the checksums of blocks anywhere in the web page image 21b previously stored into the Proxy server's cache memory. When, with this comparison, the Proxy server is informed that blocks contained anywhere in the refreshed snapshot image 22b (instead of only in the current viewable area 23 of the Portable Device's display screen in the refreshed snapshot image 22b) have the same checksums as any block in the cached web page image 21b, the Proxy server instructs the Portable Device, in the following order, to copy those blocks from the web page image 21a stored into the device's cache memory; decompress them; store them into the Portable Device's display memory and assemble them on the basis of their position coordinates in the snapshot image 22b which coordinates are sent from the Proxy server to the Portable Device along with the Proxy server's instructions; if some of those blocks are positioned in the current viewable area of the Portable Device's display screen in the refreshed snapshot image 22b, display them on the Portable Device's screen from the display memory location; and store these blocks' new positions into the Portable Device's cache memory for that web page. The subsequent operations, starting with the Proxy server sending compressed data to the Portable Device for new or modified blocks contained in the current viewable area of the Portable Device's display screen in the refreshed snapshot image 22b, are then executed as detailed above in the previous example, except for the following two improvements resulting from this embodiment. First, if some blocks located elsewhere than in the current viewable area of the Portable Device's display screen in the refreshed snapshot image 22b are copied in the manner described in this embodiment, and should the user scroll over them, they are ready to be instantly displayed on the Portable Device's screen from the display memory. Second, as the Proxy server in this embodiment no longer needs to compute and compare checksums when the user scrolls over to a new viewable area in the refreshed snapshot image 22b, it can immediately respond to a scrolling command by sending compressed data for new or modified blocks, if any, contained in the new viewable area of the Portable Device's display screen in the refreshed snapshot image 22b.

### Alternative to the Principal Embodiment—No Data is Stored into the Proxy Server

In another embodiment of the invention, the Proxy server does not store into its cache memory a mirror copy of web page images stored into the Portable Device's cache memory, nor any other information. As in the principal embodiment of this invention, though, the Portable Device saves in its cache memory the checksums ascribed to blocks of data stored therein and previously computed by the Proxy server. When the Proxy server loads a new web page, or when the content of the currently-viewed web page is refreshed, the Proxy server takes a snapshot image of the new or refreshed web page displayed on its virtual display. The Proxy server then computes checksums for blocks of data positioned in the current viewable area of the Portable Device's display area on this snapshot image. Depending on the user's action that triggered the request for the new or refreshed web page, one of the two following sequences of events follows.

If the user's action entails that the Portable Device is informed of the web page to be requested—for instance, the user types the URL of a web page in the browser's search bar—the Portable Device communicates to the Proxy server all checksums stored into the Portable Device's cache memory for this web page. This communication is sent alongside or shortly after the user's action that initially triggered this request, which implies that the Proxy server is likely to have received these checksums by the time it has computed checksums for blocks of data positioned in the current viewable area of the Portable Device's display area with respect to the snapshot image of the new or refreshed web page. Possessing all the required information, the Proxy server thus performs a comparative analysis between the just computed checksums for blocks of data in the current viewable area of the Portable Device's display area, one block at a time in sequence, and the checksums previously received from the Portable Device. Once this analysis is completed, the Proxy server sends to the Portable Device display instructions or data, or both, in the same manner as in the principal embodiment detailed above.

If the user's action entails that the Portable Device is not informed of the web page to be requested—for instance, the user clicks on a link, which click is only interpreted afterwards by the Proxy server—the Proxy server communicates to the Portable Device information identifying the requested or refreshed web page. This information is sent after loading the new or refreshed web page and computing checksums for blocks of data positioned in the current viewable area of the Portable Device's display area, so it may include the just computed checksums, as well as the locations of their corresponding blocks of data. The Portable Device thereafter checks whether it possesses stored data associated to this web page, and it sends to the Proxy server all computed checksums saved for that cached web page image, if any. If the Proxy server receives checksum information from the Portable Device, the Proxy server subsequently performs a comparative analysis between the computed checksums of blocks of data in the current viewable area of the Portable Device's display area, one block at a time in sequence, and the checksums just received from the Portable Device. Once this analysis is completed, the Proxy server sends to the Portable Device display instructions or data, or both, in the same manner as in the principal embodiment detailed above. If the Proxy server did not receive checksum information from the Portable Device, it can immediately start sending data to the Portable Device—including checksums ascribed to each block—and display instructions in the same manner described above.

Compared with the principal embodiment of the invention, no data needs to be stored into the Proxy server's cache memory according to this embodiment, although this effect comes with a performance cost: for requests by which the Portable Device does not immediately possess information identifying the requested web page, the Proxy server has to wait for the Portable Device to later transmit information to the Proxy server before the comparative checksum analysis can be performed therein. The alternate embodiment described above whereby, prior to sending any data for a web page image, the Proxy server initially computes checksums and performs a comparative checksum analysis for blocks located anywhere in a just loaded web page image (instead of only for the initial viewable area of the display area), can be translated to the embodiment disclosed in this paragraph.

### Alternative to the Principal Embodiment—Only Checksums are Stored into the Proxy Server

In another embodiment of the invention, the Proxy server does not store blocks of data into its cache memory, but only saves the checksums ascribed to blocks of data stored into the Portable Device's cache memory. When the Proxy server loads a new web page, or when the content of the currently-viewed web page is refreshed, the Proxy server takes a snapshot image of the new or refreshed web page displayed on its virtual display, and it computes checksums for blocks of data positioned in the current viewable area of the Portable Device's display area on this snapshot image. Then, the Proxy server performs a comparative analysis between the computed checksums of blocks of data in the current viewable area of the Portable Device's display area on the snapshot image, one block at a time in sequence, and the checksums previously saved into its cache memory. Once this analysis is completed, the Proxy server sends to the Portable Device display instructions or data, or both, in the same manner as in the principal embodiment detailed above, except that it cannot indicate precisely to the Portable Device the storage location of blocks of data that should be copied from the Portable Device's cache memory. Compared with the principal embodiment of the invention, no data needs to be stored into the Proxy server's cache memory according to this embodiment, although this effect comes with a performance cost since both the Proxy server and the Portable Device have to scan through more information in order to respectively execute the checksum comparative analysis and copy blocks of data. The alternate embodiment described above whereby, prior to sending any data for a web page image, the Proxy server initially computes checksums and performs a comparative checksum analysis for blocks located anywhere in a just loaded web page image (instead of only for the initial viewable area of the display area), can be translated to the embodiment disclosed in this paragraph.

### Alternative to the Principal Embodiment—Order of Display

In an alternate embodiment, blocks of data copied by the Portable Device from its cache memory may be displayed on the Portable Device's screen from the Portable Device's display memory simultaneously with these blocks being stored into the Portable Device's display memory, instead of only thereafter. Likewise, in this alternate embodiment, blocks of data transmitted to the Portable Device from the Proxy server may also be displayed on the Portable Device's screen from the Portable Device's display memory simultaneously with these blocks being stored into the Portable Device's display memory, instead of only thereafter. The rest of the principal embodiment of the invention applies normally to this alternate embodiment.

### Prior Art Virtual Display

According to the prior art, when the Proxy server's browser receives content from a web page server, blocks or parts of this web page image are virtually displayed as a virtual image on the Proxy server, which then takes a single frozen image frame or snapshot of the virtual image and, as is substantially detailed above, transmits blocks of data or display instructions, or both, to the Portable Device.

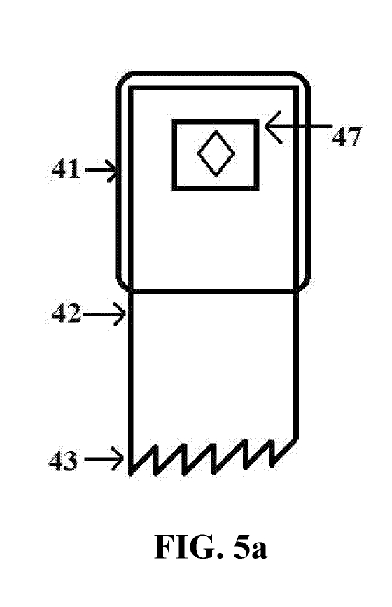

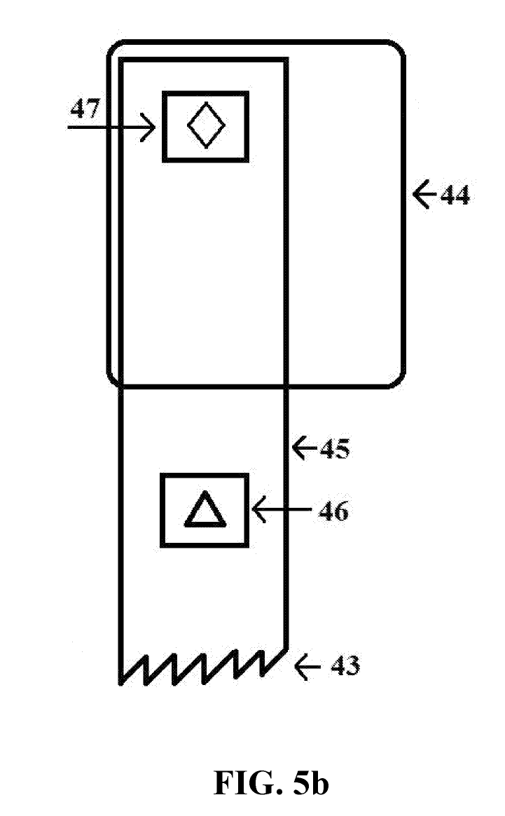

As illustrated in FIG. 5a, the dimensions of the Portable Device's display screen 41, which Portable Device the Proxy server communicates with in a network, determine to a certain extent—not necessarily with a one-to-one area ratio—the standard dimensions of the virtual image 42 that would normally be displayed on the Proxy server by its browser after receiving content from the web page browser. On the one hand, the width of most web pages, based on the content received from a web page server for a device, is usually small enough to be entirely displayed on the screen 41 of the Portable Device, and consequently to fit entirely within the standard virtual image 42 of the web page virtually displayed on the Proxy server. On the other hand, the height of web pages is typically too considerable to be entirely displayed on the Portable Device's screen. If the dimensions of the Portable Device's screen are communicated to web page servers, the amount of content sent for this web page by the web page server to the Proxy server takes these dimensions into account. The height limitation of the Portable Device's screen is thus indirectly passed on to the browser's standard virtual image virtually displayed on the Proxy server. Therefore, it happens frequently that a requested web page hosted by the web page server contains too much information for it to be entirely transmitted to the Proxy server, and thus to be entirely displayed on this standard virtual image upon the initial transmission of data. In these cases, the web page server only transmits partial content for the requested web page to the Proxy server's browser, by taking into consideration the declared size limitations of the Portable Device's screen. After the browser virtually displays this partial content as a virtual image 42 on the Proxy server (the incompleteness of this content being represented in FIG. 5a by a break 43), the Proxy server takes a snapshot image of this virtual image and sends to the Portable Device blocks of data or display instructions, or both, that allow the Portable Device to render part of the web page image on its display screen 41.

If the user scrolls down or clicks on a link that shifts the image display down, the resulting command is instantaneously communicated to the Proxy server. Depending on whether relevant data for that lower area had already been sent to the Portable Device, the Proxy server then sends data or instructions, or both, to the Portable Device to display on the Portable Device's screen the lower portion of the virtual image, which now corresponds with the current viewable area of the Portable Device's screen. Furthermore, as still contemplated in the prior art, if the user scrolls down or clicks on a link that shifts the image display down to the image's limit 43 representing the end of the web page's incomplete image, the Proxy server is again instantaneously informed of this event. It interprets the event as a request to be sent to the web page server to the effect that additional content for the web page should be transmitted. This additional content is transferred from the web page server to the Proxy server's browser, and eventually to the Portable Device through the same process by which the initial content was sent. It is also possible for the Proxy server to interpret a request for additional content for the web page on the basis of the user's shown intentions, for instance, by scrolling quickly toward the bottom of the page; by clicking on a link that shifts the display area to a position of the web page that has not been loaded on the Proxy server; because, for this specific web page, the user's history reveals that other portions of the web page are usually scrolled to, etc. When combined with the principal embodiment of this invention, each partial image of a web page that is transmitted to the Portable Device is stored in the Portable Device's and the Proxy server's cache memories, as substantially described above. These steps are repeated as necessary, depending on the user's clicking or scrolling down commands and on the amount of content that the web page comprises.

### Inefficiency of the Prior Art—Refreshments of a Web Page

When additional content is requested by the Proxy server's browser to a web page server, the web page server takes into account any modification or update that took place in higher portions of the refreshed web page to determine the content of the currently-requested portion of the web page. These changes include advertisement banners or other text or graphic elements that have been added, inserted as a response to user scrolling, deleted, modified (e.g., changed in size) or moved at another position in the web page hosted on the web page server between the moment a previous portion of the web page's content was transmitted to the Proxy server and the Portable Device, and stored in their cache memories, and the later instance an additional portion is called up. As a consequence of this refreshment, based on prior art methods, some blocks of data that were originally sent in a previous portion of the web page transmission may be sent anew in a subsequent one. Likewise, if the user scrolls back up to a portion of the web page that was previously viewed, the Proxy server's browser sends a request to the web page server for refreshed content to be sent for that portion of the web page. This content is analyzed and processed by the Proxy server using the method disclosed above regarding refreshed content after an additional element has been inserted during user navigation of a web page. Therefore, every time a new portion of a web page is requested or a previously-viewed portion of a web page is refreshed, redundant or unneeded transfers of data between the Proxy server and the Portable Device are likely to happen, which in turn affect negatively the Portable Device's bandwidth consumption and speed performance. By decreasing the likelihood of cases in which new or refreshed portions of web pages are requested to a web page server, the following embodiments of the invention reduce the amount of data transferred from the Proxy server to the Portable Device and thus conserve on bandwidth consumption and improve the Portable Device's performance. In a preferred embodiment, the following embodiments are combined with the principal embodiment of this invention, extensively detailed above, for a more efficient reduction of data transmission.

### Additional Embodiment—Virtually-Fabricated Display Screen

The first of these further embodiments of the invention is two-part, the first part of which is illustrated in FIG. 5b. In it, the Proxy server simulates, for web page servers, a virtually-fabricated display screen 44, whose dimensions are greater than those of the actual Portable Device's screen 41 (in FIG. 5a). From there, with the first part of this embodiment, every time a web page server transmits content information for a web page or for a portion of a web page to the Proxy server, more content is sent by the web page server and received by the Proxy server, where it is then displayed virtually before being sent to the Portable Device. Hence, the virtual image 45 associated with this virtually-fabricated larger display screen 44 is taller than the virtual image (42 in FIG. 5a) whose height would have been determined by the dimensions of the actual display screen (41 in FIG. 5a). For example, if the content that the user is interested in is a specific picture 46 received in accordance with this first half of the embodiment, as extra content for an initial transmission, the user does not need to request additional content for this web page. This outcome reduces, in some circumstances, the likelihood that the Proxy server inefficiently sends to the Portable Device additional or modified data that is unwanted or unneeded by the user.

In some cases, the content that the user is interested in is a specific picture 47 that is not received as part of a transmission's extra content in accordance with the first half of this embodiment (compare with FIG. 5a). In those circumstances, the Proxy server potentially sends to the Portable Device, as a result of this incomplete embodiment, data that the user does not desire or need and that would not have been sent by relying strictly on prior art processes. To dispense with these inefficient situations, the second half of this embodiment of the invention incorporates a particular prior art process of server operations. In this prior art process, the Proxy server first divides the virtual image of every web page portion received from a web page server into two or more sections. The first of these sections is defined as the area of the initial viewable area of the Portable Device's display screen, supplemented by a small field around it; in other words, as the area for which the Proxy server initially sends data to the Portable Device in accordance with the standard first and second display priorities in the prior art. Next, and in the manner substantially described above, the Proxy server takes a single frozen image frame or snapshot of each section of the web page image and divides them into blocks of data. However, the Proxy server only sends data or display instructions, or both, to the Portable Device regarding the first of these sections, not for the other. The Proxy server would send data to the Portable Device for the second section, and so forth with respect to the other sections should the virtual image be divided into more than two sections, only if the user showed intent of viewing that section—for instance, by scrolling toward it; by clicking on a link that shifts the display area to a position within that section; because, for this specific web page, the user's history reveals that this section is usually scrolled to, etc.

### Detailed Example—Virtually-Fabricated Display Screen

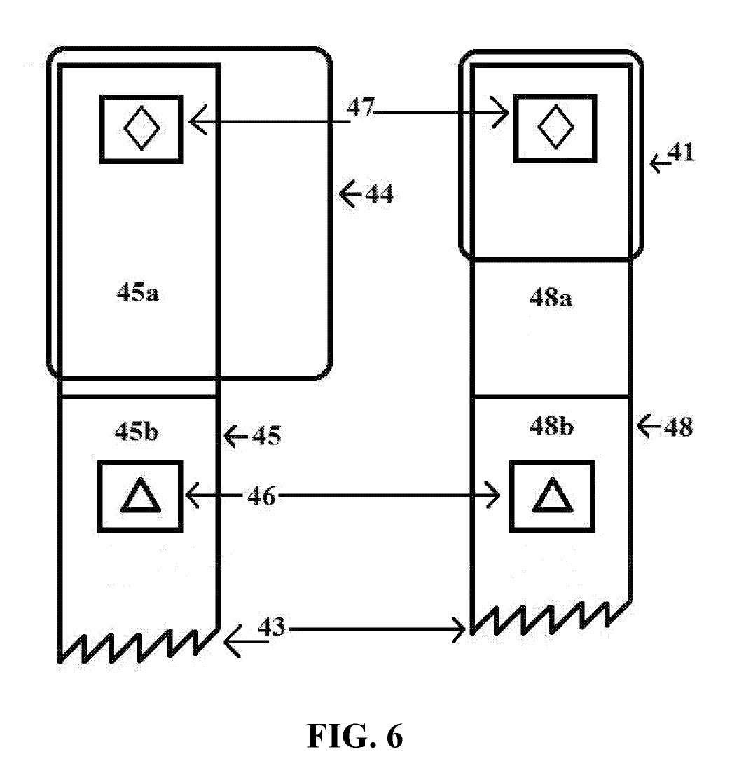

As a particular example of the combined halves of this embodiment, illustrated in FIG. 6, a web page server is requested to transmit content for a web page to the Proxy server. Along with this request, the Proxy server's browser communicates to the web page server the dimensions of a virtually-fabricated larger display screen 44. The web page server thereupon transmits to the Proxy server content for that web page, whose amount is determined by the dimensions of the virtually-fabricated screen 44. Thus the size of the virtual image 45 displayed on the Proxy server by its browser is larger than what would have been the standard size of the virtual image (42 in FIG. 5a). Shortly afterward, the Proxy server divides its virtual image 45 into two sections 45a & 45b. Then, in the manner substantially described above, the Proxy server takes a snapshot image 48 of the sections of the virtual image, divides sections 48a & 48b of the snapshot image 48 into blocks of data, and sends display instructions or data, or both, to the Portable Device regarding content of section 45a of the Proxy server's virtual image 45. More specifically, the Proxy server first sends data or display instructions, or both, for the viewable area of section 48a that is currently occupied by the Portable Device's display screen 41. Thereupon, the Proxy server sends data or display instructions, or both, to the Portable Device for the rest of section 48a of the snapshot image 48, to be stored into the Portable Device's display and cache memories and immediately displayed should the Portable Device's display area be scrolled over another area within section 48a. The proxy server sends data for section 48b only if the user shows intent of viewing that area. If the only content that the user is interested in is a picture 47 located in the first section 45a of the virtual image 45, the user is unlikely to show intent to view other sections of the web page image. With this specification, only data for the first section, which is defined in exactly the same terms as a hypothetical first image section associated with the standard prior art method, is received by default by the Portable Device. Therefore, the transfer of data ensuing from this two-part embodiment should usually not be less efficient than with the standard prior art order of priority in data transmission. Yet, as mentioned above with reference to the picture 46 located in the second section 45b of the virtual image 45, this embodiment has the potential, in many circumstances, of being more efficient than prior art processes.

### Additional Embodiment—“View More” Button

In a further embodiment of the invention, the number of instances in which accidental or unprompted transfers of data from the Proxy server to the Portable Device, for additional portions of a web page, is significantly decreased or nullified. In the prior art, the Proxy server automatically and instantaneously interprets the user scrolling down or clicking on a link that shifts the image display down to the image's limit 43, representing the end of the virtual display's and the snapshot's incomplete images (45 & 48 of FIG. 6), as a request for additional content for that web page to be transmitted. In some cases, this process causes accidental or unprompted transfers of data, for instance, when the content that the user is interested in and to which the display area is scrolled is an element 46 close to the end limit of these web page images.

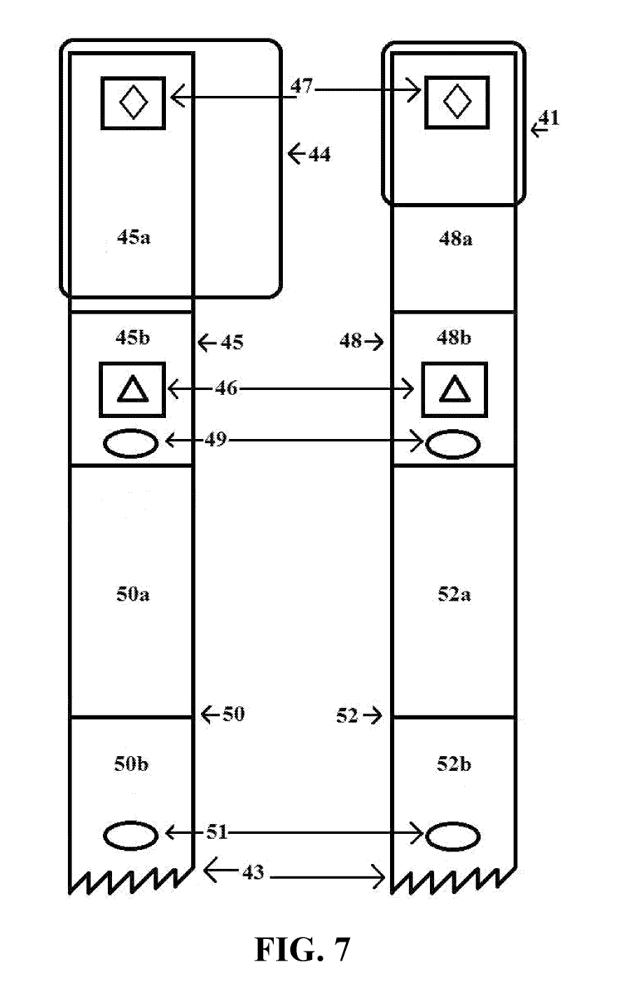

In this embodiment, scrolling down or clicking somewhere that shifts the image display down to the images' limits 43 is no longer interpreted as a request for additional content of a web page to be sent to the web page server. Instead, as illustrated in FIG. 7, the Proxy server inserts a button 49 at or near the bottom limit of every last section (in this particular example, 45b) of web page portions (45) that it has received from a web page server and potentially divided into sections. This button indicates to the user that there exists more content for this web page, and that clicking on this button triggers additional content to be sent to the user. For example, to indicate the button's function to the user, a short phrase such as “View more” or “See more” could be inscribed on it. This button is copied in the snapshot image 48 of the virtual image and then sent to the Portable Device alongside data for section 48b should this data be sent to the Portable Device in the manner disclosed above. If the user clicks on it, the Proxy server's browser sends a request to the web page server for additional content to be transmitted, and it displays this new portion 50 of the web page in the assigned web page image of the Proxy server. Then, in accordance with the previously-disclosed embodiment of this invention, the Proxy server separates this new portion of the web page image into multiple sections (50a & 50b if there are only two as in this particular example); inserts a new button 51 at the bottom of that portion's last section (50b if there are only two sections); takes for these additional sections a snapshot image 52 whose sections 52a & 52b are attached to the previous snapshot image for this web page, and sends data or display instructions, or both, to the Portable Device regarding the first of these additional sections 52a, as substantially described above. These steps would be sequentially repeated for each additional portion of the web page requested by a user.

In an alternate embodiment, scrolling down or clicking somewhere that shifts the image display close to the images' limits 43 is still no longer interpreted, in itself, as a request for additional content of a web page to be sent to the web page server. Instead, the Proxy server's browser sends a request to the web page server for additional content to be transmitted on the basis of the user's shown intentions, for instance, by scrolling quickly toward the bottom of the page; by clicking on a link that shifts the display area to a position of the web page that has not been loaded on the Proxy server; because, for this specific web page, the user's history reveals that other portions of the web page are usually scrolled to, etc. In this alternate embodiment, clicking on a button 49 is but one way by which the Proxy server can interpret the user's intentions of viewing the next portion of the web page. The rest of the previously-disclosed embodiment of the invention applies normally to this alternate embodiment.

By ensuring that data is only sent as a response to a user's request (e.g., loading a web page), shown intentions (e.g., scrolling toward other sections) and specific commands (e.g., clicking on a button), these further embodiments of the invention reduce the amount of data that the Proxy server needs to send to the Portable Device. In addition to improving the performance of the device and reducing bandwidth consumption, these more efficient processes make it significantly less likely for the Proxy server to send to the Portable Device data in which the user is not interested. In this invention's preferred embodiment, these advantages combine with the principal embodiment of this invention, in which a checksum comparative analysis is executed, to provide an even more efficient process for sending data to the Portable Device and displaying it. When a user scrolls back up in a web page after multiple portions of the web page image have been sent from the Proxy server to the Portable Device and displayed on the device's screen, it is likely that a modified, deleted or added element in one of the first portions of the refreshed web page causes the position of a large number of blocks of data to have shifted in comparison with blocks stored in the Portable Device's and the Proxy server's cache memories. As described in the detailed examples above, in application of the correlation analysis of the prior art, the Proxy server would have to send over again to the Portable Device all of these shifted blocks of data for areas in which the Portable Device's display is moved to. In application of the checksum comparative analysis included in this invention's preferred embodiment, only new or modified blocks—whose internal content is actually different from the content of any block stored into the Portable Device's and the Proxy server's cache memories—need to be sent from the Proxy server to the Portable Device.

### User-Agent String

As mentioned above with respect to the size of the Proxy server's virtual image displayed on it by its browser, information sent to web page servers by the Proxy server's browser, most notably the components of User-Agent strings, can be altered in a way that modifies the web page servers' interactions with the Proxy server's browser. In various cases, these manipulations allow the Proxy server to send less data to the Portable Device and thereby reduce the Portable Device's bandwidth consumption and improve the device's performance and speed. The next embodiment of the invention discloses a method for selecting the browser-identification information that the Proxy server's browser communicates to web page servers, so that the amount of data transferred to the Portable Device is further reduced while still maintaining a minimally-satisfying navigation experience to the user. In this invention, browser-identification information can be conveyed in any manner from the Proxy server to web page servers. However, in the preferred embodiment of the invention referred to hereinafter, the browser-identification information is conveyed in components of User-Agent strings.

### Prior Art—Browser-Identification Components of User-Agent Strings

According to the prior art, the User-Agent strings that are communicated to web page servers during the user's navigation contain browser-identification components that typically either disclose true information about the browser or cloak and alter its actual identity for another browsing application. This way, if the web page server offers different versions for a web page in accordance with different browsing applications, the Proxy server can change the version that it would receive. In the prior art, whether real or simulated, the browser-identification information communicated to web page servers by a Proxy server's browser generally stays the same throughout the user's navigation on the Internet. However, many web page servers only offer adapted versions of their content to specific browsing applications, and it is possible that the Proxy server's browser does not identify itself as one of them. Moreover, taking into account the method that is substantially described above for data transfer from the Proxy server to the Portable Device, the browser identity that minimizes the amount of data transferred to the Portable Device may not be the same for different web pages. In other cases, the browser identity that leads to the least amount of data being sent from the Proxy server to the Portable Device has the disadvantage of not offering a satisfying navigation experience to the user, taking into consideration the Portable Device's characteristics. The embodiment of the invention disclosed hereinafter avoids these pitfalls and reduces the amount of data transferred from the Proxy server to the Portable Device, thereby conserving on bandwidth and improving the Portable Device's performance without neglecting usability. It consists of a method for the Proxy server's browser to adapt the browser-identification components of its User-Agent strings into the components, among those that offer a minimally-satisfying navigation experience to the user, with which the lowest amount of data is transferred to the Portable Device. This process is applied with respect to most web pages requested by the user and on a case-by-case basis.

### Additional Embodiment—Database Based on Usability and Data Transfer Performance

To perform this embodiment, the Proxy server relies on a database. This database is constituted of the web sites that are the most often requested and navigated to by typical users. For each of these websites, usability and data transfer performance are evaluated from the point of view of the user, with reference to a specific Portable Device and to each browsing application that the Proxy server's browser could potentially identify itself as.

Usability is generally assessed with reference to predetermined thresholds: either a browser offers a navigation experience to the average user that minimally satisfies this threshold, or it does not. In this way, the measurement of usability is generally translated into a discrete, binary variable. Usability can be appraised by individual human testers who rank popular websites to be included in the database, by relying on a computer program that recreates the display of web pages based on various browsing applications. Alternatively, usability can be assessed automatically. For the automated assessment, the first step is to determine the descriptive characteristics that are considered to be necessary in order for a target user to find the navigation experience of a website minimally satisfying. The characteristics could include the display speed on the Portable Device, the navigation speed when the user scrolls up, down or sideways in a web page, the navigation speed when the user requests another page in the same website to be loaded, the display arrangement of the content sent from the web page server being intuitive for the user, and so forth. When one of these aspects is measurable, minimum thresholds for user satisfaction are also established. Then, using an algorithm that integrates these settings with reference to a specific type of Portable Device, a computer application—which may run on the Proxy server—analyzes and measures these characteristics in the websites selected for the database by mimicking each of the browsing applications that the Proxy server's browser could potentially identify itself as in the User-Agent string. Hence this automated process measures usability and establishes the browsing applications that offer a minimally-satisfying navigation experience to the user. A particular example of a computer application assessing usability, whose characteristics focus on ease of use, is disclosed further below as a preferred embodiment.

Data transfer performance is assessed by estimating the bandwidth consumption for data that would be transferred from the Proxy server to the Portable Device as a consequence of requesting, accessing and navigating the website through each browsing application that the Proxy server's browser could potentially simulate. For each browsing application, a lower bandwidth consumption is interpreted as a better performance. The measurements for data transfer performance are preferably executed with an automated process, as disclosed in the preferred embodiment below.

For each website that is considered popular enough to be inserted in the database, the server determines the browser-identification components of the User-Agent string communicated by its browser as those that simulate the browsing application that provides the best data transfer performance among those that are minimally satisfying for the user's navigation experience. In the database, the browsing application that thus achieves this optimal yet minimally-satisfying performance is assigned, on a case-by-case basis for each popular website therein. In the unlikely event that no browsing application is found to offer a minimally-satisfying navigation experience to the user, the browsing application selected by the server for the database is simply the one that offers the best data transfer performance. In the equally unlikely event that, for a website, two or more browsing applications offer the same data transfer performance, and each provides a minimally-satisfying navigation experience to the user, the Proxy server selects for the database the browsing application that was rated the best for usability.

### Detailed Example—Database Based on Usability and Data Transfer Performance

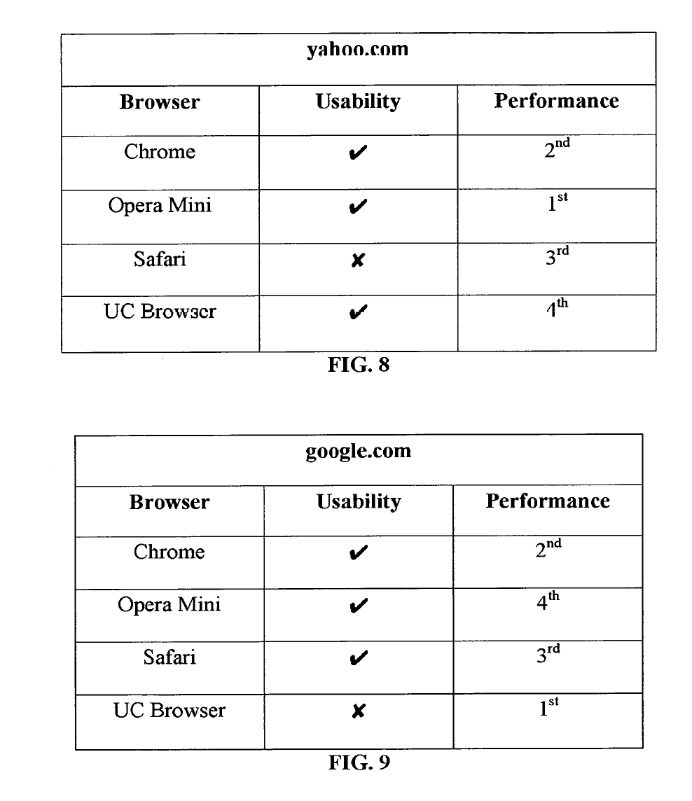

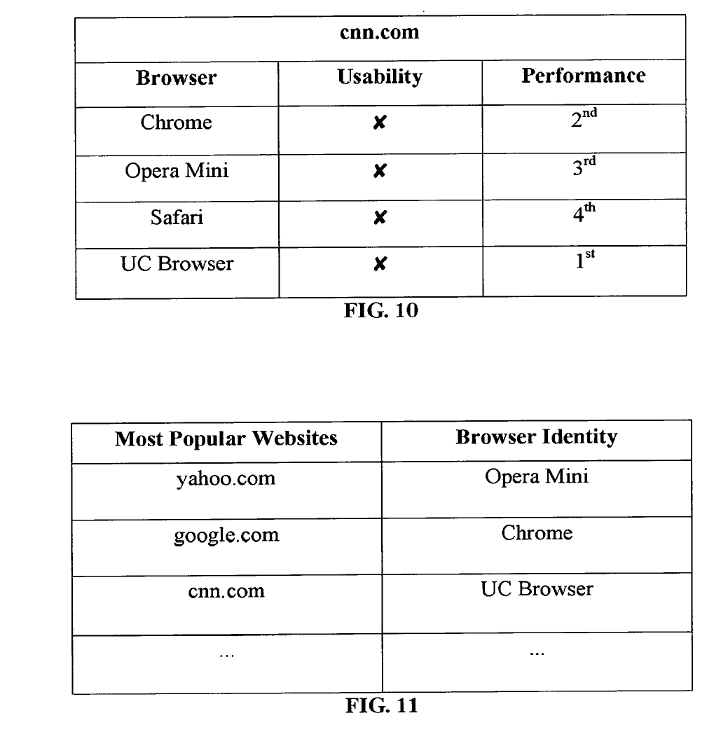

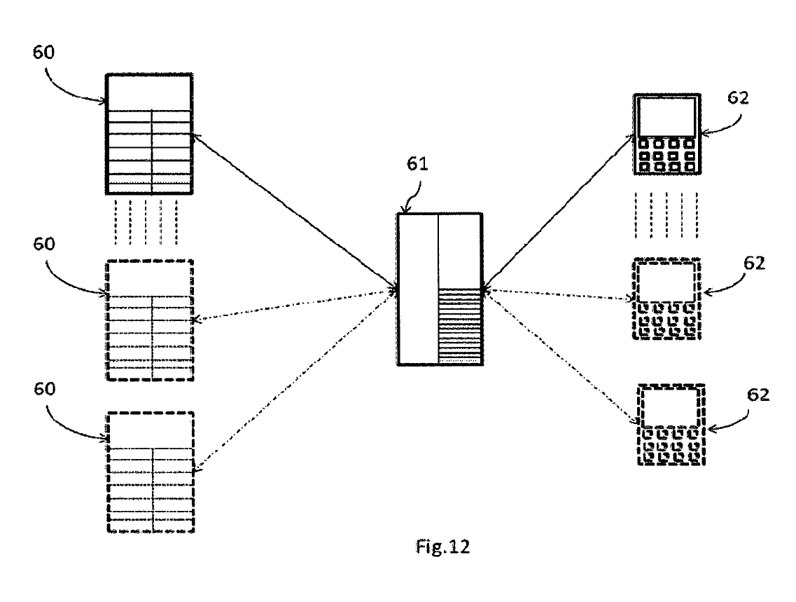

For example, supposing that there are only four candidate browsing applications—e.g., Chrome, Opera Mini, Safari and UC Browser—a database is created in which, for all of the most popular websites, one of these four browsing applications is assigned in application of the method described above. In this fictitious example, three websites are specifically analyzed in this way: yahoo.com (FIG. 8), google.com (FIG. 9) and cnn.com (FIG. 10). For yahoo.com (FIG. 8), either by running a software application applying a specific algorithm or with testers assessing the website for each candidate browser, only Chrome, Opera Mini and UC Browser are found to offer a minimally-satisfying navigation experience to the user on the Portable Device should the Proxy server's browser simulate being one of them. This outcome implies that, relying on the same evaluation method, the navigation experience provided by Safari is considered unsatisfying for the target user. Regarding data transfer, it is observed that Opera Mini performs the best, followed by—in order of performance—Chrome, Safari and UC Browser. Since the most performing browsing application for yahoo.com, Opera Mini, is found to offer to the user a minimally-satisfying navigation experience, this browsing application is assigned to yahoo.com in the database (FIG. 11). For google.com (FIG. 9), the method selected to assess usability concludes that Chrome, Opera Mini and Safari are minimally-satisfying, while UC Browser is considered unsatisfying. Regarding data transfer, UC Browser performs the best, followed by Chrome, Safari and Opera Mini, in this order. Since UC Browser has been estimated unsatisfying for the user's navigation experience, it is not assigned to google.com in the database despite being the browsing application that provides the best data transfer performance. Instead, Chrome is assigned to google.com in the database (FIG. 11) due to it being the most performing browsing application among those that, according to this embodiment's assessment, offer a minimally-satisfying navigation experience to the user. Finally, for cnn.com (FIG. 10), the process with which usability is evaluated in this fictitious example establishes that no candidates are satisfying. Regarding data transfer, UC Browser once again performs the best, followed by Chrome, Opera Mini and Safari. Despite UC Browser being regarded as unsatisfying for the user experience, it is assigned to cnn.com (FIG. 11) because it is the most performing in data transfer while no other browsing application is considered satisfying for users.

By executing this process to all popular websites, a database is created, and it is saved in the Proxy server. In application of this embodiment of the invention, when a user requests a web page hosted in a web page server, the Proxy server's browser first checks if the website associated with that web page is listed in the database previously set up and saved in the Proxy server. If it is, the Proxy server's browser cloaks its actual identity and alters the browser-identification components of the User-Agent string that it establishes with this web page server so that it simulates the browsing application assigned to that website in the database. With reference to the database created in the example above and illustrated in FIG. 11, if the user requests a yahoo.com web page, the Proxy server's browser checks this database previously set up and saved in the Proxy server; discovers that the yahoo.com website is listed in the database; observes that Opera Mini is this website's assigned browsing application in the database, and thus alters the browser-identification components of its User-Agent string with this web page server so that it simulates Opera Mini. The Proxy server's browser communicates this altered User-Agent string to the web page server alongside the user's request for content in that web page. If the web page is not part of a website listed in the database constructed beforehand, the Proxy server's browser communicates to the web page server browser-identification information with which the Proxy server's browser mimics a predetermined default browsing application. The user's subsequent requests for other web pages are also treated by checking this database. Content received through these requests is then processed by the Proxy server's browser, and some blocks of data or display instructions, or both, are sent to the Portable Device in accordance with the other embodiments of this patent's invention, to which the present embodiment can be combined.

### Preferred Embodiment—Database Built by a Computer Application on the Proxy Server

In a preferred embodiment of the process just disclosed, the Proxy server builds the entire database, for every popular website assigned in it, by assessing both usability and data transfer performance with a computer application run by the Proxy server. For usability, this computer application focuses on the interactive elements of a web page: elements that require an action by the user before they can perform their functions, such as buttons, text boxes, drop-down menus, etc. Obviously, when user input cannot be processed in elements that require interaction with the user, usability is substantially impaired. Some browsing applications are limited in this way whereby they cannot recognize some interactive elements in a web page nor, as a result, allow the user to interact with them. Usability in this preferred embodiment's database is thus measured with reference to this characteristic: for the first few image portions of some of the website's web pages that could be loaded and virtually displayed on the Proxy server by its browser, the computer application running on the Proxy server counts the number of interactive elements that are loaded, recognized and virtually displayed therein, on the basis of each potential browsing application that the Proxy server's browser could simulate. Beforehand, a threshold is predetermined to assess if the user's navigation is minimally-satisfying. For instance, usability could be considered minimally-satisfying when at least a specific percentage of the total interactive elements actually contained in the tested web pages are loaded, recognized and virtually displayed on the Proxy server by its browser, with respect to each browsing application that the Proxy server's browser could potentially mimic. As a sub-example, different interactive elements could be attributed different weights in calculating the percentage for this minimal threshold. Whatever the characteristics and thresholds that are selected, the computer application measures usability for each browsing application that could be assigned to the popular websites of the database.

In this preferred embodiment, where the process just disclosed is combined with the principal embodiment of this invention (or similar processes for data transfer), data sent to the Portable Device is constituted of compressed frames of elements in web page images. Therefore, comparisons in data transfer performance can be achieved with reference to the size of web page images loaded on the Proxy server's browser, with respect to each browsing application that it could potentially mimic. This method is actually integrated in this preferred embodiment, whereby the computer application run by the Proxy server evaluates data transfer performance: for the first few image portions of some of the website's web pages that could be loaded and virtually displayed on the Proxy server by its browser (which could be the same image portions as those that are analyzed for usability), the computer application calculates the size of these image portions, also based on each potential browsing application that the Proxy server's browser could mimic. The smaller the size of a web page's image portion that could be loaded on the Proxy server, the better the data transfer performance of its corresponding browsing application is. The computer application then relies on these measurements for both usability and data transfer performance to build the database, in the manner detailed in the general description of this process.

While this invention has been particularly shown and described with reference to an exemplary embodiment, it will be understood by those skilled in the art that various changes in form and detail may be made therein without departing from the spirit and scope of the invention. The invention in its broadest, and more specific aspects, is further described and defined in the claims which now follow.

1. A host computer performing a data processing system that reduces data transfer when serving a document to a remote device, the host computer receiving a first transmission of information, the host computer comprising a processing unit that converts the information of said first transmission into a first image, wherein the first image comprises image parts,
wherein the processing unit calculates and assigns an identifier to at least one of said image parts of the first image, or a section thereof, wherein the identifiers are based on content elements of their respective image parts, image parts that have identical content elements being assigned a same identifier, and wherein the identifiers are saved in a memory of the host computer, where they are associated to this particular remote device;
wherein, at least one of said image parts of the first image or a section thereof, and at least one of the identifiers, are transmitted by the host computer to the remote device, the remote device being capable of storing identifiers and their respective image parts of the first image or a section thereof into a memory of the remote device;
wherein, at least once afterward, the host computer receives a second transmission of information from an outside source, upon the reception of which the processing unit of the host computer converts the information of said second transmission into a second image, wherein the second image comprises image parts, and the processing unit further calculates and assigns an identifier to at least one of said image parts of the second image, or a section thereof, wherein the identifiers are based on content elements of their respective image parts, such that the image parts of the first image or of the second image that have identical content elements being assigned a same identifier;
wherein the host computer compares at least one of the identifiers assigned to image parts of the second image, or a section thereof, with the identifiers saved in the memory of the host computer that is associated to this particular remote device;
wherein, if an image part of the second image has the same identifier as an image part of the first image, the host computer sends to the remote device the position of said image part of the second image, the remote device being instructed to selectively retrieve the corresponding image part of the first image stored into a memory of the device and to display it at said position on a display screen of the remote device.

2. The host computer as claimed in claim 1 wherein a processing unit running on the host computer converts information of said first and second transmissions into said first and second images comprising image parts by rendering information of said first and second transmissions onto a virtual display of the host computer and dividing said first and second images rendered on to the virtual display into image parts by translating graphic elements of said first and second images into image parts, and by translating non-graphic elements of said first and second images into image parts on the basis of markup elements comprised in the first and second transmissions of information received by the host computer.

3. The host computer as claimed in claim 2 wherein the processing unit running on the host computer translates non-graphic elements of first and second images rendered onto a virtual display by merging with at least one adjacent markup element every markup element that would otherwise be translated into a small image part, and by dividing into multiple image parts every markup element that would otherwise be translated into a large image part.

4. The host computer as claimed in claim 1 wherein identifiers are calculated with a checksum algorithm.

5. (canceled)

6. The host computer as claimed in claim 1 wherein
before transmitting to the remote device any image part of a first or second image rendered onto a virtual display of the host computer, a processing unit running on the host computer converts said image parts in a compressed format; and
before selectively displaying image parts on a display screen of the device, the remote device is further instructed to decompress said image parts.

7. The host computer as claimed in claim 1 wherein
when the remote device is being instructed to selectively retrieve the corresponding image part of a first image stored into a memory of the remote device and to display it at said position on a display screen of the remote device, the remote device is further instructed to store said retrieved image part into a display memory of the remote device at said position just received from the host computer.

8. The host computer as claimed in claim 1 wherein identifiers assigned to image parts of the second image, or a section thereof, are compared with the identifiers saved in the memory of the host computer that is associated to this particular remote device only when the second image and a first image are rendered from information received from a same outside source.

9. The host computer as claimed in claim 1 wherein the host computer receives a second transmission of information from an outside source as a response to data received from the remote device indicating a user request for information from said outside source, which request causes the host computer to accordingly request information to said outside source and to thereafter receive said second transmission of information.

10. The host computer as claimed in claim 9 wherein the data received by the host computer from the remote device indicating a user request for information from an outside source comprises a user clicking on a link on a display of the remote device.

11. The host computer as claimed in claim 9 wherein the data received by the host computer from the remote device indicating a user request for information from an outside source comprises a user entering text input in a URL search bar.

12. The host computer as claimed in claim 9 wherein the data received by the host computer from the remote device indicating a user request for information from an outside source comprises a user clicking on a back or forward icon on a display of the device.

13. The host computer as claimed in claim 1 wherein the host computer receives a second transmission of information from the outside source as a response to data received from the remote device indicating a user scrolling, which causes the host computer to accordingly request information to said outside source and to thereafter receive said second transmission of information.

14. The host computer as claimed in claim 1 wherein
in a first transmission, from the host computer to the remote device, of image parts of a the first image, only image parts of a first section of said first image are transmitted to the remote device, and the remote device is instructed to selectively display said image parts of a first section of said first image on the display screen of the remote device; and
responsive to data received afterward from the remote device indicating a user request to display another section of said first image, the host computer transmits to the remote device at least one of the image parts of said another section of the first image, and the remote device is instructed to selectively display said image parts of a first section of said first image on the display screen of the remote device.

15. The host computer as claimed in claim 14 wherein
in a first transmission, from the host computer to the remote device, of positions of image parts of a the second image, which image parts have the same identifier as an image part of a first image previously stored into a memory of the remote device, only positions of image parts of a first section of said second image are transmitted to the device, and the remote device is instructed to selectively display the corresponding image parts of the first image stored into a memory of the remote device at said corresponding positions on the display screen of the remote device; and
responsive to data received afterward from the remote device indicating a user request to display another section of said second image, if an image part of said another section of the second image has the same identifier as an image part of the first image, the host computer sends to the remote device the position of said image part of said another section of the second image, the remote device being instructed to selectively display the corresponding image parts of the first image stored into a memory of the remote device at said position on the display screen of the remote device.

16. (canceled)

17. A host computer performing a data processing system that reduces data transfer when serving a document to a remote device, the host computer receiving a first transmission of information from an outside source, comprising a processing unit that converts the information of said first transmission into a first image comprising image parts, at least one,
wherein the processing unit running on the host computer calculates and assigns an identifier to at least one of said image parts of the first image, or a section thereof, wherein the identifiers are based on content elements of their respective image parts, image parts that have identical content elements being assigned a same identifier;
wherein, at least one of the image parts of said first image, or a section thereof and at least one of the identifiers, are transmitted by the host computer to the remote device, the remote device being instructed to store identifiers and their respective image parts of the first image or a section thereof into a memory of the remote device that is associated to this particular outside source;
wherein, at least once afterward, the host computer receives a request from the remote device to request information from said outside source, and the host computer receives from the remote device at least one identifiers of image parts of first image stored into a memory of the remote device that is associated to said particular outside source;
wherein the host computer thereafter requests information to said outside source and receives a second transmission of information from said outside source, upon the reception of which the processing unit running on the host computer converts the information of said second transmission into a second image comprising image parts, calculates and assigns an identifier to at least one of said image parts of the second image, or a section thereof, which identifiers are based on content elements of their respective image parts, image parts of the first image or of the second image that have identical content elements being assigned a same identifier;
wherein the host computer compares at least one of the identifiers assigned to image parts of the second image, or a section thereof, with the at least one identifier just received from the remote device;
wherein, if the identifier of an image part of the second image is the same as an identifier just received from the remote device, the host computer sends to the remote device the position of said image part of the second image, the remote device being instructed to selectively retrieve the corresponding image part of the first image stored into a memory of the remote device for this particular outside source and to display it at said position on a display screen of the device.

18. A host computer performing a data processing system that reduces data transfer when serving a document to a remote device, the host computer receiving a first transmission of information from an outside source, comprising a processing unit that converts the information of said first transmission into a first image comprising image parts,
wherein a the processing unit running on the host computer calculates and assigns an identifier to at least one of said image parts of the first image, or a section thereof, wherein the identifiers are based on content elements of their respective image parts, image parts that have identical content elements being assigned a same identifier;
wherein, at least one of the identifiers and at least one of said image parts of the first image or a section thereof are transmitted by the host computer to the remote device, the remote device being capable of storing identifiers and their respective image parts of the first image or a section thereof into a memory of the remote device;
wherein, at least once afterward, the host computer receives a second transmission of information from an outside source, upon the reception of which the processing unit converts the information of said second transmission into a second image comprising image parts, calculates and assigns an identifier to at least one of said image parts of the second image, or a section thereof, which identifiers are based on content elements of their respective image parts, image parts of the first image or of the second image that have identical content elements being assigned a same identifier;
wherein the host computer reports to the device the information received in said second transmission from an outside source, after which the host computer receives from the device at least one identifiers of image parts of first images-stored into a memory of the remote device;
wherein the host computer compares at least one of the identifiers assigned to image parts of the second image, or a section thereof, with the at least one identifiers just received from the device;
wherein, if the identifier of an image part of the second image rendered onto a virtual display of the host computer is the same as an identifier just received from the remote device, the host computer sends to the remote device the position of said image part of the second image, the device being instructed to selectively retrieve the corresponding image part of a first image stored into a memory of the remote device for this particular outside source and to display it at said position on a display screen of the device.

19. The host computer as claimed in claim 18 wherein the host computer reports to the remote device the information received in the second transmission by sending to the remote device at least one of the identifiers of the image parts of said second image.

20. A host computer performing a data processing system that reduces data transfer when serving a document to a remote device, the host computer receiving a transmission of information from an outside source, comprising a application that renders the information of said prior transmission onto a virtual display of the host computer, the host computer further comprising a processing unit that divides the image of the virtual display into parts, the host computer thereafter transmitting in a specific format at least one of the image parts of said image, or a section thereof, to the remote device, the device being capable of receiving them, storing them into a memory of the device and displaying them on a display screen,
wherein a processing unit running on the host computer divides said image rendered onto a virtual display of the host computer by translating graphic elements of said image into an-image parts, and by translating non-graphic elements of said image into image parts on the basis of markup elements comprised in the transmission of information received by the host computer from an outside source; and
wherein the processing unit running on the host computer translates non-graphic elements of an image rendered onto a virtual display of the host computer by merging with at least one adjacent markup element every markup element that would otherwise be translated into a small image part, and by dividing into multiple image parts every markup element that would otherwise be translated into a large image part.

21. (canceled)

22. A host computer performing a data processing system that reduces data transfer when serving a document to a remote device, the host computer sending a request for information to an outside source and receiving a transmission of information from said outside source, the host computer comprising a application that renders the information of said transmission onto a virtual display of the host computer, the host computer thereafter transmitting in a specific format the image rendered onto a virtual display of the host computer, or a section thereof, to the remote device, the device being capable of receiving it, storing it into a memory of the device and displaying it in whole or in part on a display screen,
wherein upon requesting information to said outside source, the host computer reports a size of a display screen to said outside source, wherein the reported size is selected to be larger than the actual size of the display screen of the device; and
wherein the host computer thereafter receives a higher amount of information in the transmission from said outside source than the amount of information that would have been thereafter received by the host computer if said size of a display screen reported by the host computer had been the actual size of the display screen of the device.

23. The host computer as claimed in claim 22 wherein
the host computer comprises a processing unit that divides the image rendered onto a virtual display of the host computer into parts, and
said image rendered onto a virtual display of the host computer, or a section thereof, is transmitted to the device by transmitting at least one of said image parts in a specific format to the device.

24. The host computer as claimed in claim 23 wherein
in a first transmission of image parts from the host computer to the device, only image parts of a first section of the image rendered onto a virtual display of the host computer are transmitted to the device, and the device is instructed to selectively display said image parts on a display screen of the device; and
responsive to data received afterward from the device indicating a user request to display another section of said image rendered onto a virtual display of the host computer, the host computer transmits to the device at least one of the image parts of said other section of the image rendered onto a virtual display of the host computer, and the device is instructed to selectively display said image parts on a display screen of the device.

25. A host computer performing a data processing system that reduces data transfer when serving a document to a remote device, the host computer sending a request for information for a document to an outside source and receiving a first transmission of information for said document from said outside source, the host computer comprising a application that renders the information of said first transmission onto a virtual display of the host computer as a first image, and further comprising a processing unit that divides said first image into parts, at least one of the image parts of said first image, or a section thereof, being transmitted in a specific format to the remote device, the device being capable of receiving them, storing them into a memory of the device and displaying them on a display screen,
wherein at least once afterward, responsive to data received from the device indicating a user input to display information for said document that was not transmitted in the first transmission from the outside source to the host computer, the host computer sends a request for additional information for said document to said outside source;
wherein the host computer thereafter receives an additional transmission of information for said document from said outside source, upon which the application running on the host computer renders the information of said additional transmission onto a virtual display of the host computer as an additional image, and the processing unit running on the host computer divides said additional image into parts, at least one of the image parts of said additional image, or a section thereof, being transmitted to the device, the device being capable of selectively displaying on a display screen of the device
said image parts that have just been transmitted to the device.

26. The host computer as claimed in claim 25 wherein the user input that is received by the host computer from the device, indicating that information not transmitted in a first transmission from the outside source to the host computer should be displayed, comprises a user scrolling toward the bottom of a first image displayed on a display screen of the device.

27. The host computer as claimed in claim 25 wherein the user input that is received by the host computer from the device, indicating that information not transmitted in a first transmission from the outside source to the host computer should be displayed, comprises a user clicking on a link.

28. The host computer as claimed in claim 26 wherein the host computer saves in a memory of the host computer a history of requests or inputs from the device, and the user input that is received by the host computer from the device, indicating that information not transmitted in a first transmission from the outside source to the host computer should be displayed, is interpreted from said history of requests or inputs for documents of said outside source.

29. A host computer performing a data processing system that reduces data transfer when serving a document to a remote device, the host computer sending a request for information for a document to an outside source and receiving a first transmission of information for said document from said outside source, the host computer comprising a application that renders the information of said first transmission onto a virtual display of the host computer as a first image, and further comprising a processing unit that divides said first image into parts, at least one of the image parts of said first image, or a section thereof, being transmitted in a specific format to the remote device, the device being capable of receiving them, storing them into a memory of the device and displaying them on a display screen,
wherein upon rendering the information of said first transmission onto a virtual display of the host computer as a first image, the application running on the host computer inserts a button element in said first image, which button element is translated into an image part by the processing unit running on the host computer, and the image part of said button element is transmitted to the device, the device being capable of storing the image part of said button element in a memory of the device and of selectively displaying the image part of said button element on a display screen of the device;
wherein at least once afterward, responsive to data received from the device indicating a user click on said button element displayed on a display screen of the device, the host computer sends a request for additional information for said document to said outside source;
wherein the host computer thereafter receives an additional transmission of information for said document from said outside source, upon which the application running on the host computer renders the information of said additional transmission onto a virtual display of the host computer as an additional image, and the processing unit running on the host computer divides said additional image into parts, at least one of the image parts of said additional image, or a section thereof, being transmitted to the device, the device being capable of selectively displaying on a display screen of the device
said image parts that have just been transmitted to the device.

30. The host computer as claimed in claim 42 wherein button elements inserted on a first or additional image rendered onto a virtual display of the host computer are positioned near the bottom of their respective images.

31. A host computer performing a data processing system that reduces data transfer when serving a document to a remote device, the host computer sending a request for information to an outside source and receiving a transmission of information from said outside source, the host computer comprising a application that renders the information of said transmission onto a virtual display of the host computer, and further comprising a processing unit that divides the image of the virtual display into parts, before the host computer transmits data in a specific format for at least one of the image parts of said image, or a section thereof, to the remote device, the device being capable of receiving said data, storing it into a memory of the device, and displaying image parts corresponding to said data on a display screen,
wherein upon requesting information to said outside source, the host computer reports selected characteristics of a application to said outside source, wherein the selected characteristics are determined independently from actual characteristics of the application running on the device; and
wherein said selected characteristics of a application to be reported to said outside source have been saved in a memory of the host computer before the host computer sends a request for information to said outside source.

32. The host computer as claimed in claim 31 wherein said selected characteristics of a application are reported to an outside source by the host computer through a user-agent string.

33. The host computer as claimed in claim 31 wherein the selected characteristics of a application are determined by a method that comprises a prior assessment of interactions between user inputs and the information requested by the host computer to an outside source, to which the host computer has reported characteristics of a application, and wherein at least one prior assessment has been performed for each of a plurality of sets of application characteristics that the application running on the host computer can feature when information is requested to said outside source.

34. The host computer as claimed in claim 31 wherein the selected characteristics of a application are determined by a method that comprises a prior assessment of the amount of data, in a specific format, that would be transmitted from the host computer to this specific type of portable device, wherein at least one prior assessment has been performed for each of a plurality of sets of browsing application characteristics that the application running on the host computer can feature when information is requested to said outside source.

35. The host computer as claimed in claim 34 wherein said selected characteristics of a application are the application characteristics that have been assessed to transmit the least amount of data, in a specific format, from the host computer to this specific type of portable device.

36. The host computer as claimed in claim 34 wherein the method that determines the selected characteristics of a application further comprises a prior assessment of interactions between user inputs and the information requested by the host computer to an outside source, to which the host computer has reported characteristics of a application, and wherein at least one prior assessment has been performed for each of a plurality of sets of application characteristics that the application running on the host computer can feature when information is requested to said outside source.

37. The host computer as claimed in claim 36 wherein said selected characteristics of a application are the application characteristics that have been assessed to transmit the least amount of data, in a specific format, from the host computer to this specific type of portable device among those sets of browser application characteristics for which it has been assessed that user inputs can be received by at least a predetermined proportion of interactive elements among the information requested to said outside source when said sets of browsing application characteristics have been reported to said outside source.

38. The host computer as claimed in claim 36 wherein said selected characteristics of a application are the application characteristics that have been assessed to transmit the least amount of data, in a specific format, from the host computer to this specific type of portable device among those sets of application characteristics for which it has been assessed that user inputs can be received by every interactive element among the information requested to said outside source when said sets of application characteristics have been reported to said outside source.

39. The host computer as claimed in claim 31 wherein the selected characteristics of a application are determined by a method that comprises a prior assessment of the size of the image that would be rendered onto a virtual display of the host computer when information is requested by the host computer from an outside source, to which the host computer has reported characteristics of a application, and wherein at least one prior assessment has been performed for each of a plurality of sets of application characteristics that the application running on the host computer can feature when information is requested to said outside source.

40. The host computer as claimed in claim 39 wherein said selected characteristics of a application are the application characteristics that have been assessed to render the smallest image onto a virtual display of the host computer when information is requested by the host computer from an outside source by reporting characteristics of a browsing application.

41. A data processing method implemented by a host computer for reducing data transfer when serving a document to a remote device, the method comprising the host computer receiving a first transmission of information from an outside source, wherein the host computer comprises a processing unit that converts the information of said prior first transmission into a first image comprising image parts,
wherein the processing unit running on the host computer calculates and assigns an identifier to at least one of said image parts of the first image, or a section thereof, wherein the identifiers are based on content elements of their respective image parts, image parts that have identical content elements being assigned a same identifier, and wherein the identifiers are saved in a memory of the host computer, where they are associated to this particular device;
wherein, at least one of the identifiers and said image parts of the first image or a section thereof, are transmitted by the host computer to the remote device, the remote device being capable of storing identifiers and their respective image parts of the first image or a section thereof into a memory of the remote device parts of the prior;
wherein, at least once afterward, the host computer receives a second transmission of information from an outside source, upon the reception of which the processing unit converts the information of said second transmission into a second image comprising image parts, calculates and assigns an identifier to at least one of said image parts of the second image, or a section thereof, which identifiers are based on content elements of their respective image parts, image parts of the first image or of the second image that have identical content elements being assigned a same identifier
wherein the host computer compares at least one of the identifiers assigned to image parts of the second image, or a section thereof, with the identifiers saved in the memory of the host computer that is associated to this particular device;
wherein, if an image part of the second image has the same identifier as an image part of the first, the host computer sends to the device the position of said image part of a the second image, the device being instructed to selectively retrieve the corresponding image part of the first image stored into a memory of the device and to display it at said position on a display screen of the device.

42. The host computer as claimed in claim 29 wherein, upon rendering the information of said additional transmission onto a virtual display of the host computer as an additional image, the application running on the host computer inserts an additional button element in said additional image, which additional button element is translated into an image part by the processing unit running on the host computer, and the image part of said additional button element is transmitted to the device, the device being capable of storing the image part of said additional button element in a memory of the device and of selectively displaying the image part of said additional button element on a display screen of the device

43. The host computer as claimed in claim 1 wherein if an image part of the second image have different identifier from any identifier of the image parts of the first image, the host computer selectively transmits said image part of the second image and its identifier to the remote device, the remote device being instructed to store them into a memory of the remote device and to selectively display said image part just received from the host computer on a display screen of the remote device.

44. The host computer as claimed in claim 1 wherein the image part of the subsequent image rendered onto a virtual display of the host computer that has the same identifier as an image part of a prior image has a different position than said image part of a prior image that has the same identifier.
